(19) United States
(12) Patent Application Publication
(10) Pub. No.: US 2015/0073834 A1
(43) Pub. Date: Mar. 12, 2015

(54) DAMAGE-SCALE CATASTROPHE INSURANCE PRODUCT DESIGN AND SERVICING SYSTEMS

(71) Applicant: Europa Reinsurance Management Ltd., Zug (CH)

(72) Inventors: Eugene Gurenko, Zug (CH); Paolo Bazzurro, Zug (CH)

(73) Assignee: Europa Reinsurance Management Ltd., Zug (CH)

(21) Appl. No.: 14/022,909

(22) Filed: Sep. 10, 2013

(51) Int. Cl. G06Q 40/08

(52) U.S. Cl. CPC G06Q 40/08
USPC 705/4

(57) ABSTRACT

Technology-implemented systems and methods for use of a damage-scale method in the design, issuance, management, and claim servicing of a catastrophe insurance policy are disclosed. A catastrophe insurance policy is issued to insure property from wide-scale natural catastrophic events such as floods, earthquakes, and the like natural disasters. The catastrophe insurance policy includes specific damage-scale method clauses defined in the terms and conditions of the insurance policy that require use of a damage-scale method to evaluate and manage insurance claims for property damage. For example, a catastrophe insurance policy application is defined to include contractually defined insurance indemnification payouts that are tied to specific states of property damage (rather than property replacement or repair cost estimates provided by insurance loss adjustors). The insured property damage payout is determined through the application of damage-scale based computational algorithms and supporting claims management systems and technologies.

### TECHNICAL FIELD

Embodiments pertain to insurance products and technical systems used to facilitate insurance product design, management, and servicing. Some embodiments pertain to the use and application of damage-scale methods in the design and servicing of catastrophe insurance products, including methods and systems implementing damage scale evaluation techniques, algorithms, and related technical measurements.

### BACKGROUND

Property catastrophe insurance policies typically indemnify policyholders from property damages caused by such perils as flood, wind, earthquake, and the like natural hazards. These insurance policies are designed to compensate the policyholder for losses based on indemnity principles, e.g., to make the policyholder “whole” after occurrence of an insured event. For example, when an insured risk causes damage to a given insured property, the cost of property repairs or replacement will be assessed and an indemnity payment equal to the assessed amount will be made to the insured party (subject to the policy terms and conditions and the insured policy limit). In the aftermath of natural disasters affecting numerous insured at the same time, the process of loss adjustment typically takes a long time to complete and often involves a considerable degree of human judgment. To determine the amount of indemnity payments, insurers employ insurance loss adjusters, which are tasked with evaluation of property damages and determining the scope of loss and the types of repairs needed to restore the property to its original pre-event condition.

While traditional indemnity-based insurance products are suitable for covering idiosyncratic risks (e.g., uncorrelated risks like fire or motor vehicle accidents) that cause only a few insurance claims at a time, they are ill-designed to deal with systemic risks (e.g., highly correlated risks from a catastrophe) that may be affecting thousands of properties at the same time. For example, in a case of a large and devastating earthquake in a densely populated area, insurers may face thousands of claims at the same time while the number of loss adjusters available to address the claims remains very limited (often the same as prior to a catastrophic event). As a result, it may take many months for an insurance company to complete loss assessments for many thousands of insured properties affected by the event. Further, due to an element of subjectivity involved on the part of a loss adjustor in the assessment of insured property damages, the process is often fraught with disputes over the specific amount of compensation due to a homeowner, which further complicates and prolongs the claims settlement process. As a result, an insurance claims settlement process resulting from large catastrophic events may take many months or even years to complete, causing considerable life disruptions for the insured and society.

### BRIEF DESCRIPTION OF THE DRAWINGS

FIG. 1 illustrates a framework for consumer interactions with an insurance policy underwriting system and a claim servicing system according to an example described herein.

FIG. 2 illustrates an overview of party interactions in establishing a catastrophic damage scale-based insurance product according to an example described herein.

FIG. 3 illustrates an overview of data operations performed in establishing and maintaining a catastrophic damage scale-based insurance product according to an example described herein.

FIG. 4A illustrates operations performed in applying a damage scale method in a catastrophic property insurance setting according to an example described herein.

FIG. 4B illustrates operations performed in a damage scale method claims management system for servicing of a catastrophic damage scale-based insurance product according to an example described herein.

FIG. 5 illustrates a block diagram of characteristics of a damage scale-based insurance product according to an example described herein.

FIG. 6A illustrates an earthquake damage scale for building damage caused by an earthquake event according to an example damage scale-based insurance product described herein.

FIG. 6B illustrates a flood damage scale for building damage caused by a flood event according to an example damage scale-based insurance product described herein.

FIG. 7A illustrates a flowchart of an overview for establishing a damage scale-based insurance product according to an example described herein.

FIG. 7B illustrates a flowchart of an overview for determining a settlement of a damage scale-based insurance product according to an example described herein.

FIG. 8 illustrates a flowchart of processing operations performed by an insurance claim servicing system for evaluation of a damage state for a damage scale-based insurance product according to an example described herein.

FIG. 9 illustrates an example system configuration of an insurance claim servicing system arranged to process data for use with a damage scale-based insurance product according to an example described herein.

FIG. 10 illustrates an example of a computer system to implement techniques and system configurations according to an example described herein.

### DETAILED DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

The present disclosure illustrates various techniques and configurations to enable the design, establishment, underwriting, maintenance, servicing, and settlement of an insurance policy for large-scale, multi-property damage events. Such large-scale property damage events are further referred to herein as “catastrophe” or “catastrophic events.” Catastrophic insurance events may include but are not limited to earthquakes, fires, floods, hurricanes, tornados, tsunamis, wind storms, and like natural events that result in large-scale damage to multiple properties over a geographic area.

The present disclosure provides detailed examples of the application of a damage-scale method in the design and servicing of catastrophe property insurance products. The design of such products involves the addition of specific damage-scale method clauses in insurance policy terms and conditions, while the servicing of catastrophe insurance products may utilize the damage-scale method in the management of insurance claims arising from property damage caused by natural catastrophic events to insured property. In brief, the use of a damage-scale method in property catastrophe insurance includes contractually defining and then linking pre-defined insurance indemnification payouts to specific scales (e.g., states) of property damage—rather than property replacement or repair costs estimates provided by insurance loss adjustors. Further, the use of a damage-scale method in property catastrophe insurance enables such indemnification payouts to be determined through the application of a damage-scale method computational algorithm(s) and supporting claims management technologies.

The examples that follow describe numerous building blocks that facilitate accurate and efficient usage of a damage-scale method in catastrophe property insurance. In one example further detailed herein, insurance products are defined with reference to a multi-category damage scale, with categories on the scale ranging from no damage or existing damage to a property structure, to complete collapse or loss of the property structure. This damage scale is accompanied by a damage evaluation algorithm and damage manifestation standards, which are used to categorize any damage to the property structure to a category (state) of the damage scale. In addition, the evaluation algorithm and damage manifestation standards for a damage scale may be applied to multiple insured properties. This enables a more accurate and uniform assessment of damages across multiple properties upon the occurrence of a catastrophic event. The damage scale method may be used in a defined insurance product along with a variety of supporting technological applications to improve the design, underwriting, issuance, and servicing of insurance policies, and facilitate settlement of claims arising from such policies. These technological applications include automated and data-driven techniques of processing information related to insured property damages. For example, claims data processing relying on a remote sensing claims management system may be used to detect the severity of property damages caused by a catastrophic event. Ground-based standardized photographic and video image data collected by trained surveyors may also be used to provide inputs for a damage-state-calculation algorithm to perform measurements of damage states specific to each insured property affected by a catastrophic event.

### Damage Scale Insurance Policies

As described with the examples herein, an insurance product may include a damage scale based indemnification clause for pre-defining the amount of indemnity payments for a given property damage category as set out by the adopted damage scale. By performing a series of standardized visual observations of property damages documented either with air-borne or ground-based digital photo and video imagery or a combination of the two, the user of the damage scale method can then process the collected visual data through a damage calculation and classification algorithm to arrive at the damage classification of each affected property. Any insurance claim payout for the property will be then tied to the category of damage calculated by the damage scale computation algorithm. This results in two significant efficiencies. First, a consumer can choose an insurance policy with an agreed upon payout value, and thus can receive a known in advance indemnity payment immediately upon classification of the property damage into the discrete damage category. Second, an insurer can considerably reduce the internal costs of claims processing, while at the same time improving the consistency of damage assessments and shortening the time required for settling claims from widespread losses. To summarize, the benefits of using a damage scale-based insurance approach are many, including: (1) considerably increased speed of claims settlement; (2) reduced cost of claims settlement; (3) increased transparency (for both consumers and insurance providers).

The claims process of damage scale based insurance policies, in particular, relies on the efficient documentation and measurement of property damages caused by a catastrophic insurance event. Damage scale insurance policies provide recovery for individual consumers based on image-based “loss reporting,” rather than individual building component repair/replacement cost based “loss adjusting” by insurance loss adjustors. To calculate the amount of insurance payouts, the insurance settlement process based on visual loss reporting utilizes a damage scale classification algorithm, rather than specific estimates of replacement costs of destroyed or damaged elements of dwellings. To successfully implement damage scale insurance policies, clear rules should be defined for the evaluation of respective claims prior to an insured event. This, in other words, includes collection and maintenance of visual data for insured properties; and following a natural disaster, production and processing of specific visual damage data that is then used as input in a damage scale based damage classification algorithm. The data values maintained and processed in connection with a damage scale insurance policy may include data collected from consumers, data collected from insurers or commercial providers of property data and digital imagery, risk information, regional and local damage measurements, as well as property-specific information. Therefore, a wide variety of data processing systems and configurations, as described below, may be involved in the writing, maintenance, and servicing of damage scale-based insurance policies.

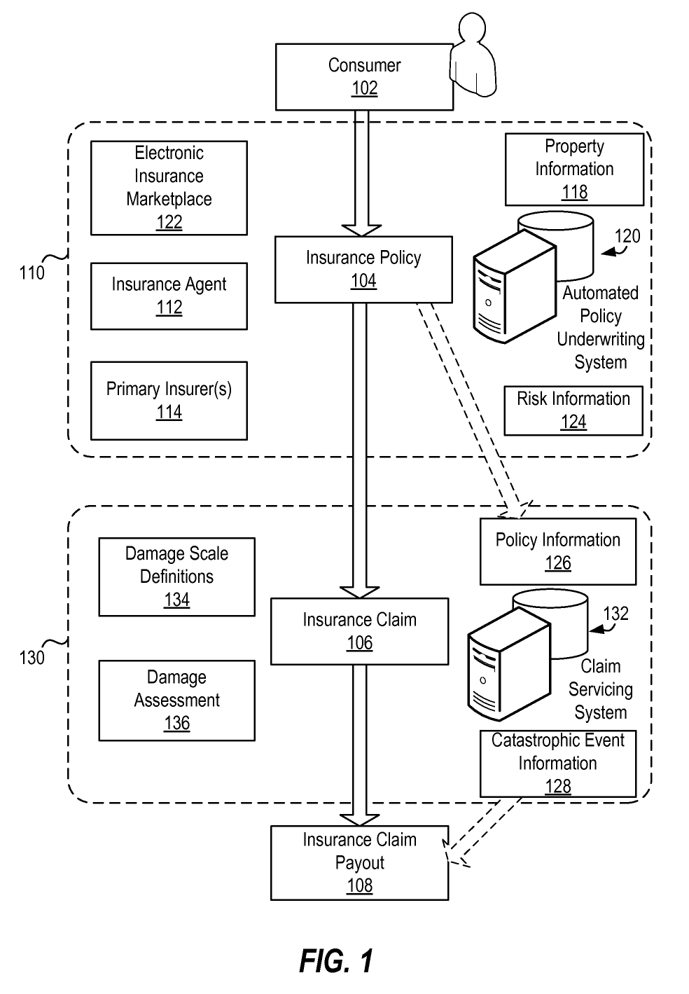

FIG. 1 provides an overview of entities, systems, and information flows involved in supporting a damage scale-based insurance policy according to one example. As depicted, a consumer 102 obtains a damage scale-based insurance policy 104 during a policy writing phase 110. The policy writing phase 110, described further below, involves the creation and definition of attributes for the damage scale-based insurance policy according to a damage scale categorization for any insurance claim. Upon occurrence of the insured event (a catastrophic damage event) during a claim phase 130, the damage scale-based insurance policy 104 becomes subject to an insurance claim 106. As a result of the insurance claim 106, an insurance claim payout 108 is determined based on the application of the damage-scale categorization algorithm and the payment is made to the consumer 102.

During the policy writing phase 110, the consumer 102 may access an electronic insurance marketplace 122 to obtain and purchase the damage scale-based insurance policy 104. The electronic insurance marketplace 122 may be operated by an insurance agent 112 via an electronic interface such as a website, and the electronic insurance marketplace 122 is configured to offer different types and variations of insurance products to the consumer 102. The damage scale-based catastrophe insurance policy 104 may be offered in the electronic insurance marketplace 122 either on a stand-alone basis or as an endorsement to other conventional insurance products issued and underwritten by one or more primary insurers 114.

The electronic insurance marketplace 122 is configured to access an automated policy underwriting system 120. The policy underwriting system 120 is a computerized processing system that accesses property information 118 and risk information 124 available for the subject property and the catastrophic event. For example, the property information 118 may be used to access specific known characteristics of the property such as building type or a construction class (e.g. masonry or reinforced concrete). The property information 118 may be compared with the historic property risk information 124 to determine the risk of damage to certain building components. For example, a classification of an insured property into a given construction class may result in modified damage scale categorization or application of a specific premium or a deductible.

The insurance policy 104, when issued, may be defined with policy information 126 and associated data. This policy information 126 and associated data is used during the claim phase 130 to provide the insurance claim payout 108 of the insurance claim 106. During the claim phase 130, the insurance claim 106 is evaluated by data processing operations in a claim servicing system 132. The claim servicing system 132 incorporates the policy information 126 derived from the insurance policy 104 and catastrophic event information 128 derived from visual imagery of property damages from a specific catastrophic event. The payout for the insurance claim 106 is determined in accordance with damage scale definitions 134 for the particular catastrophic event type, and a damage assessment 136 performed on the insured property using the damage scale method of data collection and processing.

As a result of the insurance claim 106 and processing by the claim servicing system 132, the insurance claim payout 108 is made for the insurance claim 106. The insurance claim payout 108 is specific to the damage scale for a given catastrophic peril, as different types of damages will be experienced and evidenced from different types of catastrophic events (for example, damage caused by flooding versus an earthquake will differ significantly, even if the insurance claim payout 108 reached for these different events is similar). The claim servicing system 132 and other aspects of the claim phase 130 may invoke a number of automated and human-assisted actions and mechanisms to input and process data.

### Policy Design and Servicing of Damage Scale-Based Insurance Policies

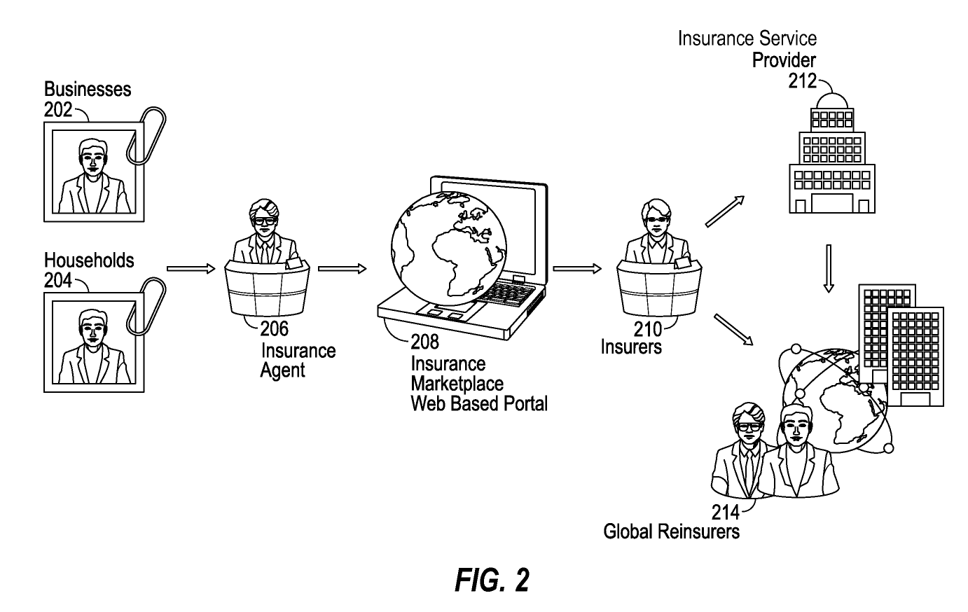

The policy design and writing phase of a damage scale-based insurance policy may involve the coordination of multiple parties including insurance agents, insurers, reinsurers, and associated service providers. FIG. 2 illustrates a scenario for the generation of an insurance policy for consumers including businesses 202 and households 204. As shown, the businesses 202 and households 204 interface with insurance product offerings through an insurance agent 206. The insurance agent 206 may provide insurance product offerings on behalf of one insurer (while an insurance broker can similarly offer products on behalf of one or more insurers 210). The insurance product offerings provided by the insurance agent 206 may include damage scale-based insurance policies for one or more types of catastrophic perils, in addition to other policies such as indemnity-based insurance policies.

The insurance product offerings may be offered through an electronic marketplace, such as an insurance marketplace web-based portal 208. The insurance marketplace web-based portal 208 may be configured as a turn-key insurance platform, customized for particular insurers 210 or an insurance agent 206, which sells common damage scale-based insurance products. For example, an insurance service provider 212 may host and operate the insurance marketplace web-based portal 208 on behalf of the insurers 210 and insurance agent 206 to sell structured insurance products at predefined premium rates.

The insurance service provider 212 may use the electronic marketplace to oversee consistent sales, marketing, and underwriting of insurance products according to defined standards. For example, the insurance service provider 212 may use the electronic marketplace to ensure that damage scale-based policies are underwritten in compliance with standards set by global reinsurers 214, to ensure unimpaired risk transfer to the global reinsurance market. In addition, the insurance service provider 212 may use common marketing, trademarking, and branding to offer consumer-recognizable products via the insurance marketplace web-based portal 208. Accordingly, the insurance service provider 212 may provide a quality control process to ensure that the insurance products sold comply with suitable credit quality standards, jurisdictional requirements, claims servicing requirements, and the like.

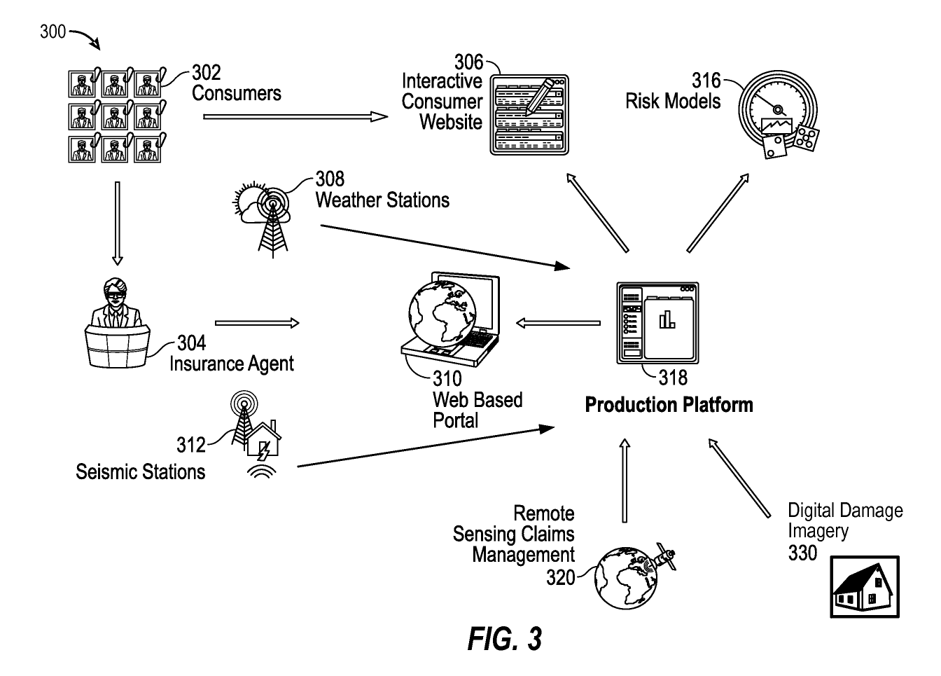

FIG. 3 provides an overview of data transactions and interactions 300 performed in connection with the issuance and servicing of a damage scale-based insurance product. The issuance of the policy again involves a set of consumers 302 interacting with an insurance agent 304 through an electronic platform such as a web-based portal 310. The web-based portal 310 stores relevant property and risk information for the particular property to be insured, with this information obtained from the consumers 302, the insurance agent 304, or from other data sources. Relevant data and information for the respective policies may be accessed and serviced by the consumers 302 through interactive systems such as an interactive consumer website 306.

Various technical capabilities for claims detection and management may be provided through processing systems interfaced with a production platform 318. These technical capabilities may include catastrophic event detection, damage assessment data, and various automated and data-driven techniques for sensing when and to what extent damage has occurred to a particular area or insured property. For instance, seismic stations 312 (for earthquake risks, for example) and weather stations 308 (for flood risks, for example) may provide real time data essential for activating damage scale based insurance policies. Providers of digital damage imagery 330 (such as ground-based loss reporting crews or air-borne sources of digital imagery) provide another set of crucial data for successful processing of claims arising from damage scale based policies damages. A back-end processing platform, the production platform 318, provides content and data processing for the web-based portal 310 and determines insurance product and policy characteristics using the data available to the web-based portal 310 and from other data sources. The production platform 318 may evaluate many properties for the issuance of an insurance policy using a number of metrics and data sources, including risk models 316, and various types of human inputs.

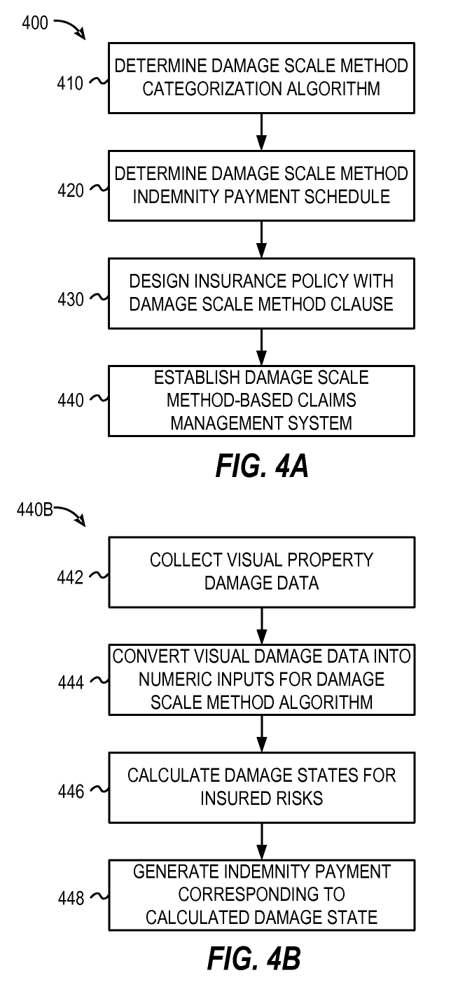

FIG. 4A provides an overview of a flowchart 400 illustrating a full-cycle of a damage scale-based insurance product design according to one example. As described below, the damage scale method may be implemented by one or more technological systems and framework components.

Operation of the systems and framework may begin with the determination, design, or selection of a damage scale method henceforth referred to as “Loss Categorization Algorithm” (operation 410). This algorithm allows an estimation of the extent of structural damage caused by natural catastrophic events to individual building components and a building as a whole using comparison of processed property damage data to a damage scale. This comparison may be based on a systematic examination, categorization, and mathematical processing of different manifestations of physical damage in individual building components (e.g., cracks, breaks in wall connections, collapses, etc.). The universe of structural damage manifestations and combinations of thereof is then converted into an engineering-based damage scale, which in turn consists of a set of discrete damage states that represent discernibly different levels of building performance. One significant benefit of a damage scale method implementation of a loss categorization algorithm is that it: (a) may replace the traditional loss adjustment process with a series of structured steps that lend themselves to automation; (b) may reduce the element of judgment on the part of a loss adjuster from the damage estimation process; (c) may significantly increase the speed and quality of claim processing in the aftermath of large catastrophic events; and (d) considerably reduce the costs of claims management for an insurer.

Each damage state is associated with a range of monetary losses needed to repair or replace the affected building, which together form the basis for the determination or construction of the damage scale method indemnity payment schedule (operation 420). The indemnity payment schedule closely approximates the real costs to be incurred by an insured in repairing or replacing a property for a given damage state. The damage scale method indemnity payment schedule along with a brief description of the damage scale method-based damages states are then combined together in a damage scale method indemnification clause (operation 430), which may be added to an insurance policy's terms and conditions.

Finally, to provide efficient claims management service to owners of catastrophic insurance policies with a damage scale method indemnification clause, a damage scale method claims management system is established (operation 440). Use of a claims management system considerably reduces the time needed to settle claims from large catastrophic events without incurring extra costs and losing accuracy of damage assessments. More detailed operations of an example claims management system configured for operation with the damage scale method are further illustrated in FIG. 4B.

FIG. 4B provides a flowchart of presentation of operations 440B performed by a claims management system implementing a claims management process under the damage scale method according to one example. The damage scale method based claims management process begins with collection of visual damage data from insured properties (operation 442), which can be obtained by obtaining systematically documented (e.g., documented in accordance with a certain algorithm) photographic evidence of damages sustained by different building components of the insured property due to an insured catastrophic peril. Such imagery can be supplied by specially trained crews of surveyors, commercial providers of airborne image data and, in some cases, even insured property owners.

The visual property damage data may be then converted or translated into numeric estimates of loss for individual building components by a team of remotely based structural engineers trained in the specific damage scale method (operation 444). These numeric inputs of loss serve as input to the damage scale method algorithm and a damage scale method computation tool. For example, a software system or appropriately configured computer system may be used to perform a calculation of a damage state for an insured risk (operation 446).

Using the calculation of the damage state, the appropriate indemnity payment corresponding to this calculated damage state may then be determined and generated (operation 448). To ensure the quality of damage scale method based damage estimates, the final damage states calculated by the damage scale method software or system may be checked or verified for consistency by a senior structural engineer against the provided damage images (or other suitable captured data).

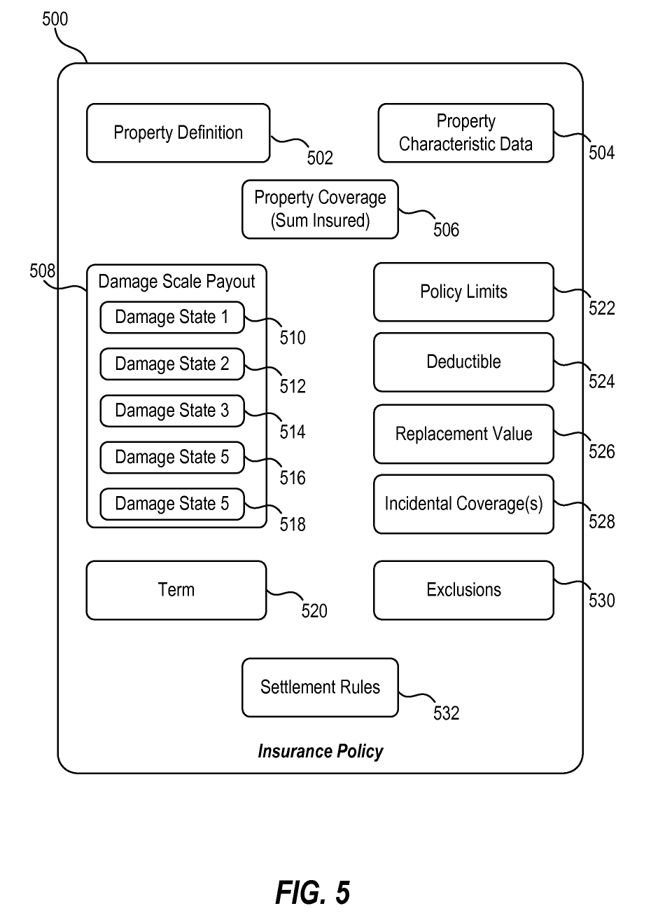

FIG. 5 provides an illustration of data types maintained for a damage scale-based insurance policy 500 issued for a catastrophic event. Each of the following characteristics of the damage scale-based insurance policy 500 are designed to be stored and maintained as data values on behalf of the damage scale-based insurance policy 500. Although the ultimate insurance policy represents a contractual obligation between two parties, the damage scale-based insurance policy 500 is accompanied by specific and discrete data values that can be electronically read, represented, modified, and processed by technological systems (e.g., computing systems such as the web-based policy underwriting system 120, and the claim servicing system 132, the insurance marketplace web-based portal 208, the web-based portal 310, the production platform 318, among other systems).

As illustrated, the damage scale-based insurance policy 500 includes a property definition 502 and property characteristic data 504. The property definition 502 may provide a definition of which particular portions of the property structure (e.g., walls, foundation, roof, floor, windows, doors, stairs, etc.) are covered by the insurance policy. The property characteristic data 504 may provide a definition of the particular characteristics of the property structure, such as which building materials are in use, the state of any pre-existing damage, the size and assessed value of the property structure, and the like.

The damage scale-based insurance policy 500 provides a payout consistent with a definition of a property coverage 506. The property coverage 506 provides a definition of the specific sum insured, and may set a limit on the total aggregate indemnity value payable of any property structure. The property coverage 506 may include a value defined to be no greater than a calculated replacement value, but greater than some minimum value. The property coverage 506 may also include levels of coverage for contents of the property structure, auxiliary structures, debris removal expenses, temporary living allowance, and other reimbursement attributes appropriate for damage caused by catastrophic events.

Financial definitions of the damage scale-based insurance policy 500 may include a definition for policy limits 522, a deductible 524, a definition of a replacement value 526, and incidental coverage(s) 528 for additional property or property characteristics. Other financial definitions used with insurance products may also be included for the damage scale-based insurance policy 500.

The payout for the damage scale-based insurance policy 500 is determined in accordance with a damage scale payout 508 defined according to the specific catastrophic event covered by the insurance product and the construction class of the building. The damage scale payout may include enumerated levels of payouts, each corresponding to a specific amount of damage. In one example, for a given construction class (e.g. masonry) five damage states are defined for use with the damage scale-based insurance policy 500, with progressively increasing payouts defined as a percentage of insured limit. These damage states may include a first damage state, “Damage State 1” 510 corresponding to a small percentage of insured limit, a second damage state “Damage State 2” 512 corresponding to a larger but still relatively small percentage of insured limit, a third damage state “Damage State 3” 514 implying a significant indemnity payment, a fourth damage state “Damage State 4” 516 triggering a payment of most of the insured limit, a fifth damage state “Damage State 5” 518 corresponding to a total loss and thus entailing the highest level of coverage under the property coverage 506 (e.g. the full insured limit).

The damage scale-based insurance policy 500 may also contain additional definitions governing any payout, including provisions for a term 520 of the damage scale-based insurance policy 500, and defined exclusions 530 for coverage of the damage scale-based insurance policy 500. In addition, the damage scale-based insurance policy 500 may include defined settlement rules 532 used for the assessment of the damage scale payout 508 or for other conditions of how and when a payout under the damage scale-based insurance policy 500 may or may not occur.

Other information specific to the type of policy may be maintained for the damage scale-based insurance policy 500. For example, the policy may record detailed information about the building components, including the class and year the building was constructed. Such information may be correlated to the quality of the building materials used, building practices at that time, and like information relevant to damage incurred after a catastrophic event. Such information, which may be critical to a proper damage evaluation, should be provided to the underwriter when the damage scale-based insurance policy 500 is written.

Although a single data structure and data set is depicted in FIG. 5, it will be understood that the data values for the damage scale-based insurance policy 500 may be included within a computing system, stored on a storage medium, transmitted over a network, or involve any number of electronic forms. Further, the data values and structure depicted in FIG. 5 may be part of a larger data store, or include different named and substituted elements.

### Damage State Evaluation

As discussed herein, a catastrophic event insurance policy may be written to provide a claim payout based on a damage scale. The damage scale is used to define a set of discrete damage states that are meant to represent different levels of building performance after the catastrophic event. Each damage state is also associated with a range of monetary losses needed to repair or replace the affected building. By relying on digital visual data collected by surveyors, providers of air-borne and satellite imagery or insured themselves, a remotely based property damage analyst is expected to be able to categorize the damage observed in the building after a catastrophic event as belonging to one of an enumerated set of damage states.

The expected losses and, therefore, the insurance payout after the application of the policy conditions are based on an estimate of the global damage state that an insured building is in after a catastrophic event. The estimation of the global damage state can be carried out using a methodology defined for observed damages from a particular catastrophic event type (such as a definition for an earthquake, flood, or the like). The general application of this methodology is summarized as follows.

First, damage patterns to all major building components are used to evaluate the observable state of the building structure after a catastrophic event. The particular damage pattern depends on the type of the catastrophic event, the building type, the building material characteristics, and other variables. For example, in a building after an earthquake, the severity of a damage pattern and, therefore, the consequences on the building safety and monetary losses, also depends on the possible existence of adjacent undamaged columns, or walls, able to withstand horizontal and vertical forces. The precise state and the effectiveness of such structural redundancy might be only determined from an inspection by certified structural engineers which are few and typically not available for the purposes of settling numerous claims in the aftermath of catastrophic events; to approximate this data for purposes of remote processing of damage scale-based insurance claims, the definitions of the damage states are established in advance by structural engineering professionals to correlate to a particular damage pattern produced by the catastrophic event.

In one example, a damage pattern may be evidenced by states (e.g., levels) of damage to specific sets of damaged building components that are evaluated. A building type (e.g., a reinforced concrete frame (RCF) or an unreinforced masonry (URM) building type) can be divided in some number of sets of damageable components (illustrated in Table 1 below). Not all damageable components may be present in a building, as for example, stairs are not present in a one-story building.

TABLE 1
Building Component Categories by Building Type

| Unreinforced | |
|---|---|
| Masonry buildings | Reinforced Concrete Buildings |
| Masonry walls | Beams and Columns |
| Floors | Floors |
| Vaults and Arches | Infill walls |
| Stairs | Stairs |
| Roof | Roof |
| Electrical/Mechanical | Electrical/Mechanical |
| Equipment, Piping, Ducts, | Equipment, Piping Ducts, |
| Suspended Ceilings | Suspended Ceilings |

The global damage state of a building depends on the average damage state, (davg)k, of all the k=1, . . . , N damageable component sets present in a building, where, e.g., N≦6. The average damage state, (davg)k, of each component set k is the weighted average of the damage states that different components (e.g., different columns), measured as percentage of the total, are found to be in after the catastrophic event.

In one example, six damage states are defined in the damage state insurance policy to provide a categorization of the particular level of damage to the building structure and the building structure components. These six damage states may be defined to include:

a) D0: No damage

b) D1: Minor damage

c) D2: Moderate damage

d) D3: Major Damage

e) D4: Severe Damage

f) D5: Collapse (or condemned)

For example, after some catastrophic event, 20% of the beams and columns can be categorized as D3, 60% as D2, 15% as D1, and 5% as D0.

The average damage state, (d_{avg})ₖ, of the component set k can be computed as follows:

$${( {d}_{avg} )}_{k} = {\sum }_{j = 1}^{5} {d}_{jk} {e}_{jk}$$

where dⱼₖ=j is simply a numerical indicator of the damage state, namely d₁ₖ=1 for damage state D1 in component set k, d₂ₖ=2 for damage state D2 in component set k, and so on. The notation eⱼₖ indicates the percentage of all components k (e.g., 20% of all columns and beams) that are in damage state j (e.g., moderate damage, D2). For simplicity, the numerical values of all the damage extension eⱼₖ are not elicited directly but can only be specified as belonging to one of the five following ranges: 0<eⱼₖ<20%, 20%<eⱼₖ≦40%, 40%<eⱼₖ<60%, 60%<eⱼₖ≦80%, 80%<eⱼₖ≦100%. However, for an assignment of all the eⱼₖ's of a given component set k to be legitimate, the sum of the values of eⱼₖ over all j's must be equal to 100%. This condition is not automatically met but needs to be enforced. If we call Lⱼₖ the lower bound of the range of eⱼₖ selected for the damage state j, and Uⱼₖ the lower bound of the range of eⱼₖ selected for the damage state j, then the sums of the lower bounds and of the upper bounds of all the ranges selected to describe the damage experienced by the component set k are:

SLₖ=ΣⱼLⱼₖ

SUₖ=ΣⱼUⱼₖ

For an assignment of all eⱼₖ's of a given component set k to be legitimate, SLₖ must be ≦100% and SUₖ must be ≧100%. Even if the assignment is legitimate, the numerical values of the eⱼₖ's such that their sum, SEₖ, is equal to 100% need be computed. To ensure that SEₖ is exactly 100%, the eⱼₖ's are computed as follows:

eⱼₖ=Lⱼₖ+rₖ(Uⱼₖ−Lⱼₖ) where

rₖ=(100%−SLₖ)/(SUₖ−SLₖ)

This condition ensures both that SEₖ is exactly 100% and that Lⱼₖ≦eⱼₖ≦Uⱼₖ.

For example, assume that component set k is masonry walls in a three-story unreinforced masonry building. Assume now that in a building only damage states D0, D1 and D2 were observed. More severe damage states were absent. If the damage states D1 and D2 each concern separately only 20% of the walls at the first story, and no damage states D1 and D2 were observed on the walls at the second and third story, then the extension of damage states D1 and D2, referred to the whole building, would be 20%×⅓=6.7%, and hence the damage extension will be classified for both D1 and D2 as belonging to the range between 0 and 20%. In this example the rest of the walls, namely 60% at the first story and 100% at the second and third stories are completely undamaged, namely have a damage state D0. In this case the extension of D0 is 60%×⅓+100%×⅓+100%×⅓=86% and, therefore, it is assigned to the range between 80% and 100%. In this example, SLₖ=0%+0%+80%=80% and SUₖ=20%+20%+100%=140%. These values imply that r=0.33. Hence, e₀ₖ=80%+0.33×20%=86.7% and e₁ₖ=e₂ₖ=0%+0.33×20%=6.7% and SEₖ=86.7%+6.7%+6.7%=100%.

Given all the premises, it is clear that (d_{avg})ₖ may take up values that range between 0 and 5.

To facilitate this exercise, the following matrices can be used to assess the overall state of damage for all the component sets found in unreinforced masonry buildings and in reinforced concrete buildings, respectively. Note that all the cells in the matrix are populated to compute (d_{avg})ₖ for all the component sets present in a building. For example, Table 2 below provides a matrix used for evaluation of eⱼₖ's (called simply e in the table) of an unreinforced masonry building.

TABLE 2
Unreinforced Masonry Building Evaluation Matrix

| | Damage | Damage State | | | | | |
|---|---|---|---|---|---|---|---|
| | Extension | D0 | D1 | D2 | D3 | D4 | D5 |
| Beams and | e = 0 | | | | | | |
| Columns | 0 < e < 20% | | | | | | |
| | 20 ≦ e < 40% | | | | | | |
| | 40 ≦ e < 60% | | | | | | |
| | 60 ≦ e < 80% | | | | | | |
| | e ≧ 80 | | | | | | |
| Floors | e = 0 | | | | | | |
| | 0 < e < 20% | | | | | | |
| | 20 ≦ e < 40% | | | | | | |
| | 40 ≦ e < 60% | | | | | | |
| | 60 ≦ e < 80% | | | | | | |
| | e ≧ 80 | | | | | | |
| Vaults and | e = 0 | | | | | | |
| Arches | 0 < e < 20% | | | | | | |
| | 20 ≦ e < 40% | | | | | | |
| | 40 ≦ e < 60% | | | | | | |
| | 60 ≦ e < 80% | | | | | | |
| | e ≧ 80 | | | | | | |
| Stairs | e = 0 | | | | | | |
| | 0 < e < 20% | | | | | | |
| | 20 ≦ e < 40% | | | | | | |
| | 40 ≦ e < 60% | | | | | | |
| | 60 ≦ e < 80% | | | | | | |
| | e ≧ 80 | | | | | | |
| Roof | e = 0 | | | | | | |
| | 0 < e < 20% | | | | | | |
| | 20 ≦ e < 40% | | | | | | |
| | 40 ≦ e < 60% | | | | | | |
| | 60 ≦ e < 80% | | | | | | |
| | e ≧ 80 | | | | | | |
| Electrical/ | e = 0 | | | | | | |
| Mechanical | 0 < e < 20% | | | | | | |
| Equipment, | 20 ≦ e < 40% | | | | | | |
| Piping, Ducts, | 40 ≦ e < 60% | | | | | | |
| Suspended | 60 ≦ e < 80% | | | | | | |
| Ceilings | e ≧ 80 | | | | | | |

A similar evaluation process may occur for other types of buildings with differing structural components. For example, Table 3 illustrates a matrix used to compute an extension of damage in the entire reinforced concrete building per damage state.

TABLE 3
Reinforced Concrete Building Evaluation Matrix

| | Damage | Damage State | | | | | |
|---|---|---|---|---|---|---|---|
| | Extension | D0 | D1 | D2 | D3 | D4 | D5 |
| Beams and | e = 0 | | | | | | |
| Columns | 0 < e < 20% | | | | | | |
| | 20 ≦ e < 40% | | | | | | |
| | 40 ≦ e < 60% | | | | | | |
| | 60 ≦ e < 80% | | | | | | |
| | e ≧ 80 | | | | | | |
| Floors | e = 0 | | | | | | |
| | 0 < e < 20% | | | | | | |
| | 20 ≦ e < 40% | | | | | | |
| | 40 ≦ e < 60% | | | | | | |
| | 60 ≦ e < 80% | | | | | | |
| | e ≧ 80 | | | | | | |
| Infill Walls | e = 0 | | | | | | |
| | 0 < e < 20% | | | | | | |
| | 20 ≦ e < 40% | | | | | | |
| | 40 ≦ e < 60% | | | | | | |
| | 60 ≦ e < 80% | | | | | | |
| | e ≧ 80 | | | | | | |
| Stairs | e = 0 | | | | | | |
| | 0 < e < 20% | | | | | | |
| | 20 ≦ e < 40% | | | | | | |
| | 40 ≦ e < 60% | | | | | | |
| | 60 ≦ e < 80% | | | | | | |
| | e ≧ 80 | | | | | | |
| Roof | e = 0 | | | | | | |
| | 0 < e < 20% | | | | | | |
| | 20 ≦ e < 40% | | | | | | |
| | 40 ≦ e < 60% | | | | | | |
| | 60 ≦ e < 80% | | | | | | |
| | e ≧ 80 | | | | | | |
| Electrical/ | e = 0 | | | | | | |
| Mechanical | 0 < e < 20% | | | | | | |
| Equipment, | 20 ≦ e < 40% | | | | | | |
| Piping, Ducts, | 40 ≦ e < 60% | | | | | | |
| Suspended | 60 ≦ e < 80% | | | | | | |
| Ceilings | e ≧ 80 | | | | | | |

Different building components may be considered or weighted in a different fashion based on the type of catastrophic event. For example, damage to ceilings may be common in response to an earthquake; whereas damage to ceilings may be far less likely in response to a flood.

### Damage State Evaluation Example: Earthquake

In response to an earthquake catastrophic event, a surveyor (e.g., a human agent) may collect visual data (e.g. photo and video) on evident damage manifestations using a systematic and well-structured data collection protocol. The collected data is then passed on (through internet based claims management portal) to a remotely based claim analyst who will perform an evaluation of a building state to measure the state of damage based on the automated damage categorization algorithm and following the supporting methodology. An earthquake catastrophic event may provide various consequences associated with building damage caused by earthquake ground shaking, or in certain cases, the building damage that may derive from local deformation of the foundation soil. A claim analyst performing measurements of damage to the building components would then categorize the damage observed in the building as belonging to one of an enumerated set of damage states by entering numeric equivalents of visual damage manifestations to individual building components into the damage classification algorithm. In the following examples, this may include application of the six damage states (D0-D5) using the damage scale as identified above

for two types of buildings, Reinforced Concrete Frame buildings, and Masonry Buildings, is provided.

Reinforced Concrete Frame (RCF) Buildings: These buildings have a frame of vertical and horizontal elements constituted by columns and beams made of reinforced concrete, and therefore, their name of RCF buildings. Both external walls and internal partitions are typically made of masonry whose connections with the elements in the frame is often only due to mortar. The slabs are usually made of concrete and clay tiles.

Masonry Buildings: These buildings include structural elements that vary depending on the building's age and, to a lesser extent, its geographic location. A masonry categorization includes all those buildings with brick, stone, or clay tile walls without columns, beams, or framing of concrete, wood, or steel. Older buildings may have wood floors, while more recent ones (built since approximately the 1940s) may have concrete and clay tile floors or, less often, concrete slab floors.

A damage scale is independent of the building class, but the specifics of the damage states of the building class components are not. It is intuitive to understand that buildings of different classes tend to respond differently to the same level of ground shaking from an earthquake. Hence, the damage pattern and the repair strategies are customized either for a masonry building or for a reinforced concrete frame building, and, therefore, the losses associated with a damage state differ.

There are various structural characteristics of masonry and RCF buildings that, if present, may make the same pattern of damage more or less severe (e.g., rigidity or flexibility of the floors, and weight and incidental thrust of the roof structure on the supporting walls) but cannot be easily identified by untrained eyes. Characteristics that require a trained building inspector or engineer are not typically necessary for evaluation of damage for a damage scale insurance policy. Rather, the characteristics of the loss evaluation are based on human and machine-detectable damage from measurable observations after the catastrophic event.

The patterns of severe damage change the overall stability of the building and have a direct consequence on the uncertainty of the loss estimates of the intermediate damage states. More specifically, the estimates of the losses of the moderate damage and major damage states are more uncertain because more uncertainty is present in the reduction of the original capacity of the building caused by the damage. Clearly, minor damage, collapse, and, to a certain extent, the severe damage states have much clearer connotations and less uncertain loss estimates. However, the damage state corresponding to severe damage may be associated with losses in the range of 70 to 80 percent. When a building is in this damage state after an earthquake, often owners decide for a variety of reasons to demolish the building rather repair it. Therefore, severe losses may be escalated to 100% of the replacement cost of the building. Accordingly, with the particular damage scale used, the insurance policy payout may be designed to ensure that the building will always be repaired.

During the shaking from an earthquake, building damage usually occurs as a continuum with location and extent of damage increasing as the level of shaking increases. Hence, a well-crafted damage scale should include a suitable level of differentiations between damage states so that the amount and type of damage can be adequately represented as the building structure degrades. However, despite the continuum nature of the damage progression in a building shaken by an earthquake, a differentiation into too many damage states aside from being impractical is also not supported by the available data or the engineering practice of the damage repair process. For each level of damage there are only a limited number of suitable repair strategies that can be applied. For example, patterns of cracks of similar extent in a partition that are either hairline-thick or 1 mm thick are likely to be fixed using the same strategy (e.g., stucco, finishing, and painting) and, therefore, demand the same repair cost. Cracks of at least 3 mm of thickness would need to develop before a different repair strategy (e.g., epoxy injection, stucco, finishing, and painting) is warranted. By assigning a cost to each repair strategy and by accounting for the extent of damage in the building within each damage state the total repair or replacement cost associated with each damage state can be estimated, which can then be converted into a predefined indemnification payout expressed as a percent of insured sum for the building as a whole.

A suitable damage scale should also include descriptions of damage to both structural and non-structural components in different damage states. Structural damage affects the components of the gravity and lateral-load-resisting systems, such as columns and beams in RCFs buildings and load-bearing walls in masonry buildings, and potentially can have serious consequences both on the safety of the building and on the amount of monetary losses. The damage caused by earthquakes to non-structural components is important both for the assessment of the usability of the building and for the estimate of the repair costs but not for the safety of the building. Typical damage to non-structural components are those concerning plasters, coatings, stuccos, false ceilings, infill panels, non-structural roof components, covering, eaves, and parapets. Damage to water, gas, or electricity plants is also included in the non-structural damage category. It is desirable, then, to separately assess structural and nonstructural damage in case estimates of business interruption coverage, which are currently not of interest, but will be considered at a later stage.

General descriptions of the damage states for structural and non-structural components are provided for the two building types considered here. As mentioned earlier, given that in some cases the structural damage is not directly observable because the structural elements are inaccessible or not visible the structural damage states are described, when necessary, with reference to certain effects on nonstructural elements that may be indicative of the structural damage state of concern.

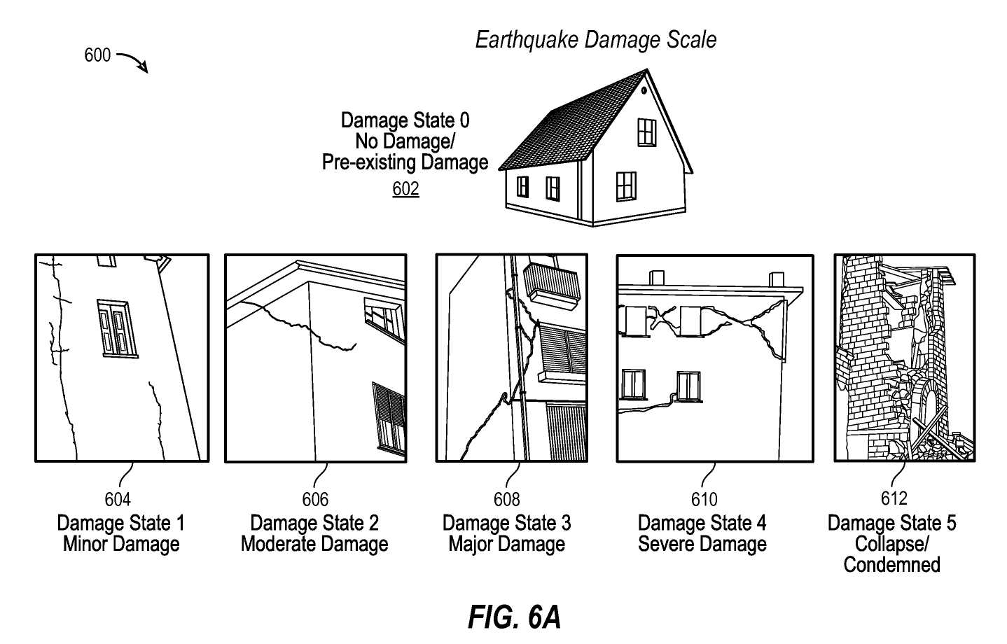

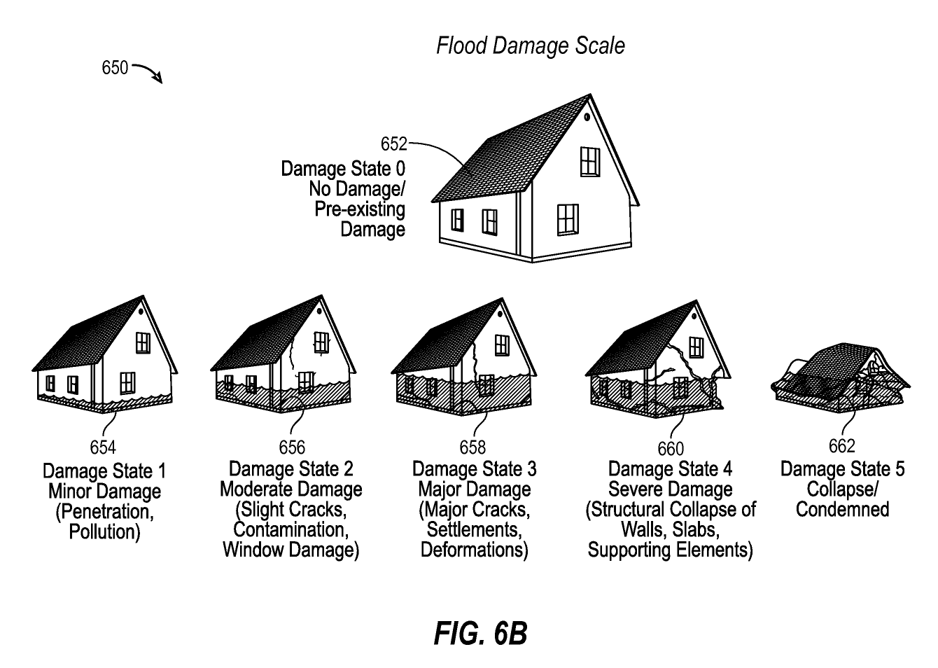

FIG. 6A provides a graphical illustration 600 of six damage states (602, 604, 606, 608, 610, 612) to a building structure caused by an earthquake. These six damage states are further described with reference to the characteristics of particular building types as follows.

Earthquake Damage—Unreinforced Masonry Buildings (URMs)

To define the severity, location and extent of damage to URMs it is advantageous to refer to the damage patterns. In the following, reference is made to cracks within the masonry walls (and not only cosmetic cracks experienced on plaster walls).

Damage State D0 (Illustration 602)—No Damage/Pre-Existing Damage. No damage from the earthquake event is evident. If damage (e.g., cracks) or out of plumb conditions are present, the damage must be pre-existent to the earthquake event.

Damage State D1 (Illustration 604)—Minor damage. Damage that does not significantly affect the capacity of the structure and does not jeopardize the occupants' safety due to falling of non-structural elements. In general, cracks are of width ≦1 mm, regardless of their distribution in masonry walls and in floors, without material expulsion, and with limited separations or slight dislocations (≦1 mm) between parts of structures, for example between walls and floors or between walls and stairs or between orthogonal walls. If vertical walls are slightly out of plumb, the damage has to be pre-existent and not influencing the structural capacity. Limited damage to the most flexible roofs (wood or steel) with consequent falling of some tiles at the edges also belongs to this damage state. Finally, falling of small portions of degraded plaster or stucco, not connected to the masonry is also often observed. Damage State D1—Component Damage may include:

Masonry walls: Localized, small flexural cracks less than or equal to 1 mm in width at the top or at the foot of masonry piers and at the openings, corners, or on the lintels of doors and windows. If the crack starts from the lintel and extends over the whole spandrel beam and similar cracks are present at the upper floors, then the damage pattern may not be localized but may instead be a prelude to the separation of all the vertical spandrel beams of the building. In that case, a more appropriate damage state would be Damage State D2. Small diagonal cracks may be evident that are less than or equal to 1 mm in width in masonry piers and in spandrel beams. Some cracks may be evident at the base of parapets.

Wall cracks in the plaster due to shrinkage or damage that occurred in the past, repaired and not reactivated, may be associated with this damage state. Small cracks due to crushing of masonry can also be observed but these cracks should be just perceptible and in any case have a width less than 1 mm. Crushed mortar and/or stone or bricks may be present but without any inner wall material expulsion. If limited to a slight symptom, it can be included in this damage state, otherwise it should be classified into a higher damage state.

Cracks due to separation of the walls, at the wall intersections if present, should be of width smaller than approximately 1 mm. This type of crack indicates the loss of connection between orthogonal walls. At damage state D1, the failure mode is just at the beginning Sometimes, it may be attributed to a reactivation of a pre-existing damage condition. Cracks may occur generally due to the localized thrust of wooden beams. If the wall damage is just perceptible and there is no bulge in the wall, it may be assumed that neither the boundary conditions nor the capacity of the masonry has been significantly altered.

Cracks can be sometimes observed in the upper part of buildings, especially when appropriate connections are missing (tie beams, tie rods, confining rings, ties). The activated mechanism generally consists in sliding of a ‘wedge’ of the wall, and the failure may extend to lower floors if effective connections are missing. If the failure is very localized and cracks are 1 mm wide or smaller, then it may be considered non dangerous and categorized as damage state D1. Slight damage to tie rods can also sometimes be detected. The lengthening of tie rods or even the permanent deformation of anchorage zones (plates, wedges, underneath masonry) indicates an excessive stress on the structural component, which has induced plastic deformations. When no local collapse is present and when the plastic deformation is not very relevant, the structure, although deformed, may be considered to have reached a somehow stable configuration. Horizontal cracks at the connection between walls and floors are sometimes present. If they have very limited dislocations (up to approximately 1 mm), then they indicate the onset of sliding at the interface between the masonry and the floor or the roof and can be associated to a damage state D1.

Visible out of plumb walls are sometimes present in old masonry buildings, even before an earthquake. However, if there is reason to believe that the out of plumb conditions have been generated by the earthquake and the residual displacement is barely perceptible and less than 0.5% of the inter story height then a damage state D1 is appropriate.

Floors: Small cracks (1mm or less) parallel to the spanning direction of the beam can be often found in case of flexible floors facilitated by the discontinuity between joists and bricks, which tends to damage the plaster underneath. This failure mode does not reduce the resistance of the structure and the damage is essentially cosmetic. Substantial absence of displacements of the bearing beams at the supports.

Vaults and arches: In many types of vaults and in masonry arches, small cracks are physiological, especially in cloister vaults or in ribbed vaults of small thickness. The presence of tie rods, buttresses, or massive walls tends to stabilize the structure but it does not completely eliminate these effects. In the risk evaluation, it is suitable to account both for the length of cracks, with respect to the element dimensions, and for the number and position of the cracks themselves. If hairline cracks less than 0.5 mm in width are present and they are rather localized, a damage state D1 is appropriate.

Stairs: In case of cantilever stairs, made of stone, wood, or steel steps and of masonry vaulted stairs, cracks should not exceed 1 mm in width.

Roof Wooden or steel roofs are generally more flexible than those in reinforced concrete buildings. If the roof covering is made of tiles, they may easily disconnect due to vertical vibrations, with consequent sliding of the internal tiles and falling of the border ones in the pitched roofs. If these phenomena are limited and the structure is substantially intact, then the damage is limited to the roof functionality and can be categorized as damage state D1.

Electrical/Mechanical Equipment, Piping, Ducts, Suspended Ceilings: minor damage to some unanchored piping and ducts can be observed. Some ceiling tiles may have moved and occasionally may have collapsed.

Damage State D2 (Illustration 606)—Moderate damage. Damage that reduces the capacity of the structure, without getting close to the limit of partial collapse of the main structural components. In general, wider (a few millimeters) and more extended cracks than those described in damage state D1 also with expulsion of material can be found in many walls. If close to openings, wider cracks due to crushing can occasionally be detected. Some separations between floors and/or stairs and walls and between orthogonal walls may also be present. Cracks of 2-3 mm in vaults are common. In wooden or steel roofs with tiles covering, damage in the secondary beams and falling of a portion of the tiles covering. Walls may be visibly out of plumb, induced by the earthquake, but in any case not larger than approximately 0.5%. Falling of non-structural objects is possible as well as significant cracking in parapets. Damage State D2—Component Damage may include:

Masonry walls: Localized flexural cracks at the base or at the top of the masonry piers and on the lintels of doors and windows, opened up to 0.5 cm, may indicate a beginning of separation between the piers and the spandrel beams and should be assigned to damage state D2. Diagonal shear cracks in masonry piers or spandrel beams of width up to 2-5 mm can also be observed within the boundaries of this damage state. Corner cracks of 2-3 mm width, which are pertinent to a D2 damage state, may be evidence of crushing failures and should be evaluated with care. The seriousness of the damage depends on the wall typology and geometry and on the damage extension that indicate a more or less compromised vertical bearing capacity. For example, if there are many openings in close proximity that reduce the resisting section of the walls, the structural risk can be considered high, especially in buildings of significant height and with poorly maintained masonry walls. In these latter cases the major damage state D3 is warranted.

Vertical cracks at wall corners, of the order of 2-3 mm or slightly wider, prove that the failure mode, characterized by loss of connection between orthogonal walls, has been clearly activated. In these cases, if the cracks are small, then damage state D2 is appropriate.

Cracks due to the localized action of floor beams should be considered as damage state D2 if there is a localized area of damage but without a serious reduction of the masonry bearing capacity, which is often associated with out of plumb conditions.

Cracks at damage state D2 have an extent such that it is possible to clearly detect the wedge of the masonry structure. When there are evident dislocations, denoting sliding of the wedge, the structural risk should be considered high enough to cause an assignment of damage state D3 or D4. If the dislocations are just perceptible, the structural risk can be considered low.

Isolated cases of tie rod failure or bond slippage that affect localized portions of the structure and are associated with a modest out of plumb conditions can be categorized in the damage state D2. Evidence of earthquake-induced global out of plumb conditions smaller than 1% can be found. They are generally associated with cracks that reflect possible separation between walls and floors. If there is bulging of the wall within the limits above but the quality of the masonry is poor, such as the double-wythe masonry kind, then this extent of damage may indicate that significant damage has occurred within the inner structure of the wall and that partial collapse may be imminent. In such cases, a more severe damage state is warranted.

Cracks with dislocations of 1-2 mm that indicate some sliding between the floor and the masonry underneath should be categorized as Damage State D2.

Floors: At damage state D2, floors show a separation from the bearing structures, generally related to out of plane failure modes of the masonry walls, and often include the sliding of the beams by less than centimeter. The support of the floor beam on the external walls, in this case, is generally not compromised. It is possible to observe some damage to the floor finishes and to the secondary beams, if present (wooden or steel floors) but no failures.

Vaults and arches: Cracks of width up to 2-3 mm at the keystone and at the haunches but without significant dislocations can be observed. At this damage state, a clear-cut separation of the vault with respect to the masonry walls should not be visible. Note that the extent of the importance of the damage to vaults should be evaluated in relation to the importance of the vault in the global structural behavior. For instance, small thickness vaults, generally used as false ceilings, play a negligible role in the global behavior and even serious damage does not jeopardize the stability of the entire building.

Stairs: Damage more severe than the previous damage state D1, but without any collapse. Cracks may not be wider than 2-3 millimeters. In case of vaulted masonry stairs, cracks similar to those described for the vaults may occur, while in the case of other types of stairs it is possible to refer to the floor damage classification.

Roofs: The general considerations on the damage pattern discussed for damage state D1 still hold. At damage state D2, however, it is possible to observe some damage to the secondary beams and some displacements at the beams supports (wooden or steel beams) but no localized failures of the secondary beams. The falling of a significant portion of tiles with respect to the total amount (for example of the order of 10-15%) may occur. In the case of reinforced concrete roofs, very limited sliding between roof and masonry walls may occur at this damage state.

Electrical/Mechanical Equipment, Piping, Ducts, Suspended Ceilings: more widespread damage to unanchored piping and ducts can be observed. Piping leaks at several locations; elevator machinery and rails may require realignment. Most tiles have moved and many have fallen, some of the steel elements of the framing system supporting the tiles may have buckled or were disconnected. Lenses may have fallen off of some light fixtures and a few of the fixtures may have fallen making localized repairs necessary.

Damage State D3 (Illustration 608)—Major damage. Damage that significantly reduces the capacity of the structure, bringing it closer to the limit of partial collapse of the main structural components. In general, wider (up to 1 cm) cracks than those described in Damage State D2 and with significant expulsion of material can be found in many walls. Significant separations between floors and/or stairs and walls and between orthogonal walls with some partial collapses in the secondary beams of the floors can be detected. Cracks of 5 mm or more in vaults and with symptoms of crushing can be found. In wooden or steel roofs with tiles covering, damage in the secondary beams and falling of a significant portion of the tiles is within the boundary of this damage state. Visible out of plumb, induced by the earthquake, but in any case not larger than approximately 1%, is sometimes present. Falling of non-structural objects is certain. Failure of many portions of parapets can be observed. Damage State D3—Component Damage may include:

Masonry walls: The damage pattern and failure mechanisms of damage state D3 are similar but more severe than those described for damage state D2. Widespread flexural cracks at the base or at the top of the masonry piers and on the lintels of doors and windows can be as wide as 1 to 1.5 cm. Diagonal shear cracks in masonry piers or spandrel beams of width up to 1 cm with visible dislocations can also be observed. Corner cracks of 5 mm or wider are likely evidence of crushing failures. Vertical cracks at wall corners, of the order of 5 mm (or slightly wider), are clear indications of the loss of connection between orthogonal walls. Damage state D3 may include severe vertical cracks and horizontal cracks.

Cracks due to the localized action of floor beams should be considered as damage state D3 if the localized area of damage is significant and there is visible out of plumb. Cracks at this damage state are such that it is possible to clearly detect the wedge of the masonry structure with evident dislocation, denoting sliding of the wedge. Failure of several tie rods or the occurrence of bond slippage that affects several parts of the structure and are associated with visible out of plumb conditions can be categorized in this damage state D3. The damage severity and related losses here are not related to the failure of the tie rods per se but to the consequences on the masonry structure caused by the tie rod failures. Evidence of earthquake-induced out of plumb conditions around 1% can be found. They are generally associated with cracks that reflect separation between walls and floors. Cracks with dislocations of up to 5 mm indicate some sliding between the floor and the masonry underneath and should be categorized as damage state D3.

Floors: At damage state D3, floors show a well-defined separation from the bearing structures, generally related to out of plane failure modes of the masonry walls, and often include sliding of the beams by a centimeter or more. The support of the floor beam on the external walls is generally not lost. It is possible to observe some damage to the floor finishes and to the secondary beams, if present (wooden or steel floors). Some localized failure of the secondary beams (wooden floors) may also occur.

Vaults and arches: Widespread cracks of width up to 5 mm or more at the keystone and at the haunches and with significant dislocations can be observed. At this damage state, a clear-cut separation with respect to the masonry walls, usually due to a wall's out of plane failure mode and facilitated by the thrust of the vaults, may occur.

Stairs: Damage more severe than the previous state D2, perhaps with some expulsion of material but without any collapse. Cracks may be as wide as 5 mm or more.

Roofs: The general considerations on the damage pattern discussed for damage state D2 still hold. At damage state D3, however, it is possible to observe damage to the secondary beams and significant displacements at the beams supports (wooden or steel beams) and localized failures of the secondary beams. A falling of a significant portion of tiles with respect to the total amount (for example of the order of 20-25%) may occur. In case of reinforced concrete roofs, some sliding between roof and masonry walls may occur at this damage state.

Electrical—Mechanical Equipment, Piping, Ducts, Suspended Ceilings: similar pattern of damage as described for the damage state D2 but more extensive and severe. Piping leaks at many locations. The suspended ceiling framing system may exhibit some localized collapse. Anchored equipment indicates stretched bolts or strain at anchorages.

Damage State 4 (Illustration 610)—Severe damage. Damage that very significantly reduces the capacity of the structure to a level very close to the limit of partial collapse of the main structural components. This state is characterized by damage heavier than that of previous states including limited partial collapses of secondary structural components. The falling of non-structural objects is certain.

Component Damage Description: Damage to structural components more severe than the previous damage state D3, with expulsion of a significant amount of structural material and/or localized collapse of bearing walls and of wall corners. This may be accompanied by a dangerous dislocation of structures and with a severely dislocated masonry wedge. Bearing walls severely damaged and on the verge of falling out of plane are associated with this damage state, if localized.

The damage to the electrical-mechanical equipment, piping, ducts, and suspended ceilings is extensive. Equipment is damaged by sliding, overturning or failure of their supports and is not operable; piping is leaking at many locations; some pipe and duct supports have failed causing pipes and ducts to fall or hang down; elevator rails are buckled or have broken supports and/or counterweights have derailed. The ceiling system is buckled throughout and/or collapsed and requires complete replacement; many light fixtures fall.

Damage State D5 (Illustration 612)—Collapse (or condemned). Damage characterized by extremely severe and irreparable damage or partial collapse of the structural components up to the complete building destruction. In the case of a building still standing, a significant out of plumb larger than 1-2% can sometimes be observed.

Damage state D5 component damage may be evidenced in a variety of states. The damage expected at this damage state ranges from buildings that are still standing but possess a very limited residual capacity to withstand aftershock and cannot be economically repaired, to buildings where complete collapses of structural and non-structural elements are evident.

### Example of Catastrophic Flooding Events

There is a fundamental difference between the need for using a damage scale when the damage is caused by earthquake ground motion and when the damage is caused by flood. The issue rests with the most suitable “observation” that an inspector can exploit to best estimate the repair cost and, therefore, the monetary losses. With the exception of a few cases, the inspector who surveys a building damaged by an earthquake does not know the level of shaking that caused the visible damage. Often, the only observable evidence by the inspector is the pattern of damage. Hence, simply for convenience, a damage scale is used to help in categorizing the observed pattern of damage in one of the possible damage states covering the entire spectrum from “no damage” to “complete collapse.”

The case of assessing damage due to flood is easier because the flood leaves behind long-lasting evidence of the most important measure of its severity, that is, the water depth at the building location. This evidence cannot be easily tampered with since watermarks are typically both clear and abundant on the structure itself and on adjacent buildings and nearby vegetation, fences, and so forth. In the case of flood, losses can be estimated directly from the height of the water and the damage (and related losses) can then be categorized into a discrete number of damage states, if so desired, only for consistency sake but this categorization is much less useful than in the case of earthquake damage.

FIG. 6B provides a graphical illustration 650 of six damage states to a building structure (without damage in Damage State D0, Illustration 652) caused by a flood, correlated to respective flooding levels. In the following, the estimation of losses in flooded buildings does not directly utilize a damage scale from visible building damage, but instead uses an important intensity measure of the flood event, the water depth.

Damage State D1 (Illustration 654)—Flooding with minor damage. Damage is typically penetration and pollution.

Damage State D2 (Illustration 656)—Flooding with moderate damage. Damage is typically slight cracks, contamination, some window damage.

Damage State D3 (Illustration 658)—Flooding with major damage. Damage is typically major cracks, settlements, building deformations.

Damage State D4 (Illustration 660)—Flooding with severe damage. Damage is typically evidenced by structural collapse of walls, slabs, or supporting elements.

Damage State D5 (Illustration 662)—Flooding resulting in collapse or condemnation of the building.

Flood insurance compensation under a damage scale-based insurance policy is based on previously agreed upon contract terms, which promise different payouts for repair or replacement of certain damaged goods caused by different levels of inundation of water that has been on the ground at some point before reaching the property.

A central role in flood damage assessment is played by a relationship between the intensity of the flood, here inundation depth, and the losses suffered by the affected building. This relationship is commonly called Damage Function.

### Example Method and System Implementations

In accordance with the techniques previously described, various machine-implemented methods, machine-readable data storage mediums, and computer system structures may be implemented to facilitate the operations of issuing, serving, and evaluating a damage scale-based insurance policy for a catastrophic event. These operations may be performed individually or as part of a larger insurance product offering and servicing system.

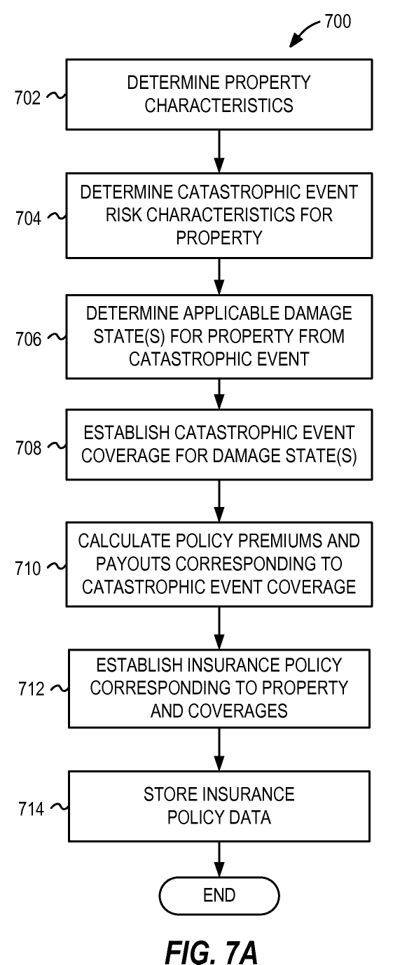

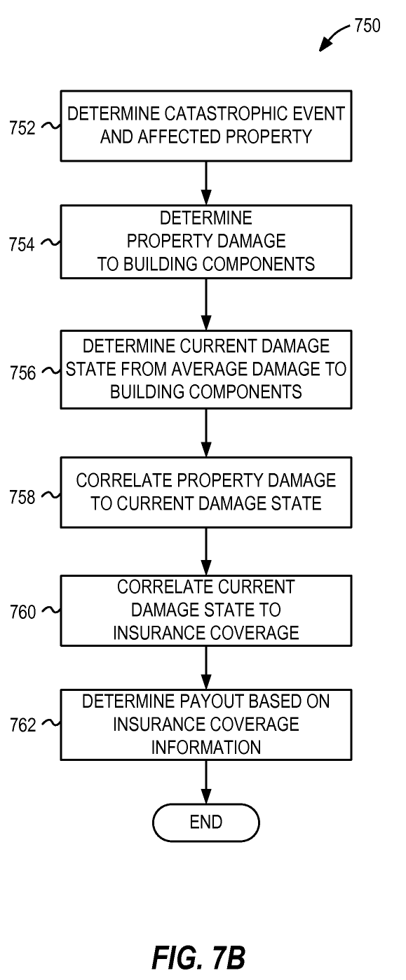

FIG. 7A illustrates a flowchart 700 of an example method workflow for generating an insurance policy for a catastrophic event. The operations of the flowchart 700 may be performed by a combination of automated and human interactive techniques, including data systems configured to perform processing on data inputs entered by human users. Some method workflows, however, may involve automated processing techniques to automate all operations of the policy generation.

First, to determine the particular coverage of an insurance policy, the property characteristics of the subject property are determined (operation 702). This may include factoring the particular building type of the property, the building material composition of the property, pre-existing damage, the value of the undamaged state of the property, and other characteristics of the property itself. In addition, the catastrophic event and risk characteristics of the property are determined (operation 704). These may include information indicating whether particular building components of the subject property are subject to more or less damage from a catastrophic event, whether the property location is at higher risk of damage from a catastrophic event, and like forecasted characteristics that may result from the catastrophic event.

Using the property characteristics and the catastrophic event risk characteristics, the applicable damage states for the property from an insured catastrophic event may be determined (operation 706). For example, this may include segmenting observable damage from the catastrophic event into six categories (such as the D0-D5 damage scale described above). Standards for evaluation of these applicable damage states may be determined based on the particular building type, the building materials used in the building, the features of the building, geographic use of the damage states, and the like.

Next, the insurance policy may be written and issued based on the desired catastrophic event coverage. The catastrophic event coverage may be established for some or all determined damage states (operation 708), and insurance policy premiums and payouts corresponding to the catastrophic event coverage may be determined (operation 710). For example, a consumer may select an insurance policy that only provides for payout of moderate to severe damage, or may utilize a high deductible on the insurance, which would preclude payouts from lower category occurrences. The insurance policy may be structured to provide any number of exclusions and coverage conditions, customized to the desired catastrophic event coverage offerings and standards defined by an insurer, underwriter, reinsurance provider, governmental regulation body, and the like.

The damage scale-based insurance policy may then be established to correspond to the particular insured property and coverage(s) (operation 712). This operation may be accompanied by various insurance payment and definition operations occurring between insurers and the consumer. Finally, the characteristics of the insurance policy and associated insurance policy data are stored (operation 714). This insurance policy data will be persisted for use with claims servicing or further activity related to the catastrophic event.

FIG. 7B illustrates a flowchart 750 of an example method workflow for determining a settlement of a damage scale-based insurance product. Again, the operations of the flowchart 750 may be performed by a combination of automated and human interactive techniques, including data systems configured to detect and measure damage to building structures and components, automatically or in conjunction with inputs and control from human users. Some method workflows, however, may involve automated processing techniques to automate operations of the policy evaluation and claims determination.

In one example, the operations for determining a settlement of a damage scale-based insurance product first include a determination of the catastrophic event and the characteristics of the particular affected property (operation 752). This may occur in connection with an automated detection of a catastrophic event (e.g., using data from seismic stations), from human reporting of a loss event, from surveillance or visual evaluation of a property, and the like. The determination of the particular catastrophic event and affected property may also involve retrieval of data on the property characteristics (determined directly from the property, from insurance policy information, or from third party data sources), such as the building type, building characteristics, and policy coverage.

The calculation of the damage state begins with a determination of property damage to building components (operation 754). This may include a detailed evaluation of classes of building components, classifications of damage states to the building components, and the like. From this determination of property damage to building components and building component categories, an average damage state of the overall building structure (a current damage state) can be determined (operation 756). Various numerical scales, classifications, and mathematical operations may be used to determine this current damage state. The current damage state and its characteristics may be correlated to a particular property damage categorization (operation 758) as classified by an insurance policy evaluation scale (e.g., one of the damage states D0-D5).

The insurance coverage information for the particular insured property may be obtained and processed. This may include information regarding pre-existing states of the building, coverage exclusions, and information that will affect the damage classification. The applicable damage states as obtained from the insurance coverage information are then correlated to the current damage state observed from the subject property (operation 760). In accordance with the insurance coverage information (and a predefined coverage level for a plurality of damage states), the payout for the determined damage state of the property can then be determined (operation 762).

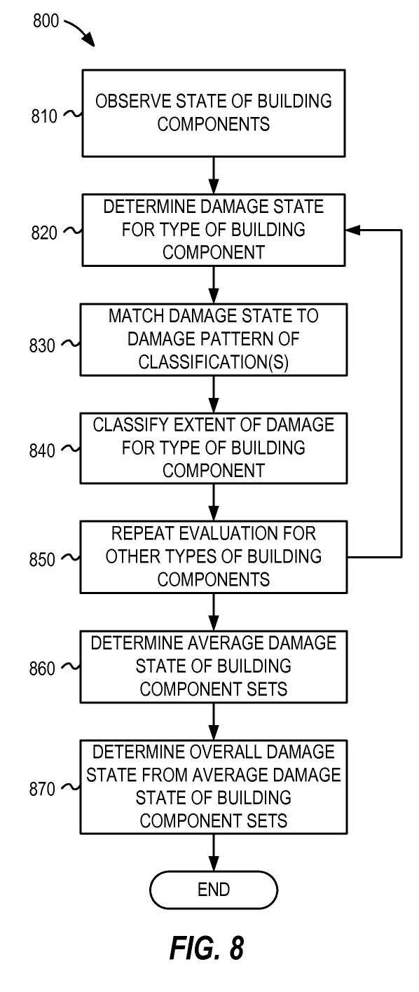

FIG. 8 illustrates a flowchart 800 of an example workflow for processing operations for evaluation of a damage state of a subject property. The evaluation operations of the flowchart 800 may be performed in connection with automated operations of an insurance claim servicing system, using data obtained automatically and with human observation. The evaluation operations of the flowchart 800 also may be modified with additional mathematical operations, weighting, rules, and other parameters as defined by an appropriate classification rule set.

The evaluation operations may be initiated by an observation of the state of the respective building components (operation 810). The observation may be tailored to the particular type of building structure and building materials in the building structure (e.g., reinforced concrete versus masonry building), and the type of catastrophic event (e.g., earthquake versus flooding). For each category, class, or type of building component, operations are performed to determine the damage of the building component type (operation 820), match any observed damage to a damage pattern established by a classification (operation 830), and classify the particular extent of damage for the building component type (operation 840). The determination and classification operations are then repeated for each type of building component evaluated (operation 850).

Based on the evaluation of the various building component types, an average damage state for the sets of building component types can be determined (operation 860). This average may be determined a weighted or unweighted average of numeric values and scales tied to the classifications. Accordingly, an overall damage state for the building can be determined from the average of the values calculated from the damage state of building component sets (operation 870). In some examples, certain building component types or classes may be excluded or weighed differently based on the characteristics of the building and the particular insurance policy definitions.

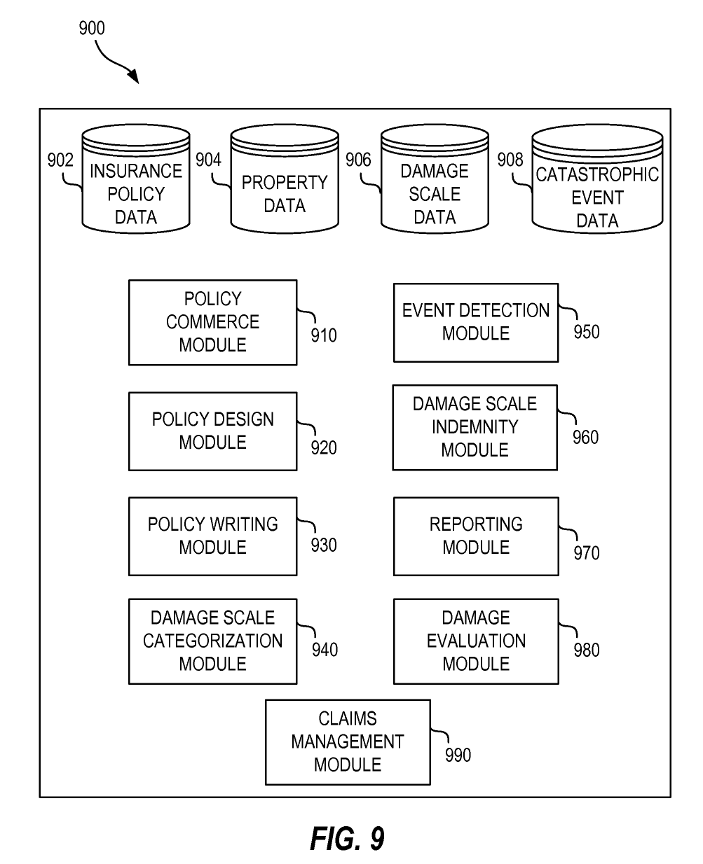

FIG. 9 illustrates an example configuration of a system architecture 900 configured to implement the presently described techniques for generating and servicing damage scale-based insurance policies. The system architecture 900 may include an electronic data store (e.g., provided with a series of data stores 902, 904, 906, 908) and electronic processing modules (910, 920, 930, 940, 950, 960, 970, 980, 990) used for performance of machine operations with the damage scale-based insurance policies. However, it will be apparent that the respective data stores and modules may be combined, integrated, or distributed in different configurations, or that a system with fewer or additional modules and data stores may be employed.

The data stores of the system architecture 900 include an insurance policy data store 902, a property data store 904, a damage scale data store 906, and a catastrophic event data store 908. The insurance policy data store 902 may be used to maintain information for particular insurance policy instances for insured properties, including coverages, conditions, and exclusions for particular insured properties according to a damage scale. The property data store 904 may be used to store information on particular insured properties, including the characteristics of the property, building component types of the property, pre-existing conditions of the property, and the like. The damage scale data store 906 may be used to store particular evaluation criteria and metrics for individual damage states (including damage state classifications relevant to a specific catastrophic event). The catastrophic event data store 908 may be used to store information for specific catastrophic events including data on the extent of damage caused by the catastrophic event.

The respective modules of the system architecture 900 facilitate operations of generating, underwriting, issuing, evaluating, and servicing a damage-based insurance policy and associated damaged-based insurance policy claims. These modules include an insurance policy commerce module 910 configured to provide an electronic interface and manage electronic data for the marketing and sale of damage scale-based insurance policies; an insurance policy design module 920 used for establishing and maintaining electronic data for characteristics of a damage scale-based insurance policy; a policy writing module 930 used for designing the damage scale insurance policy for the subject property and ensuring compliance of the damage scale-based insurance policy with underwriting standards; a damage scale categorization module 940 used for defining categorizations for assessment and determining risk attributes for the particular catastrophic event and property, for example to determine premium, deductible, and payout characteristics of the damage scale-based insurance policy; an event detection module 950 used to detect or collect information on the occurrence of a catastrophic event and an insurance claim; a damage scale indemnity module 960 configured for correlating respective damage scale categorizations to a range of monetary losses needed to repair or replace a subject property under an insurance policy; a reporting module 970 used to collect information on an insurance claim; a damage evaluation module 980 used to evaluate particular damage characteristics of a building and building components after a catastrophic event; and a claims management module 990 used to facilitate a claim settlement for a claim filed upon a damage scale-based insurance policy.

Although some of the previous examples were provided with reference to specific computerized applications (such as the insurance marketplace web-based portal 310, and the production platform 318), it will be understood that the applicability of the present system and methods may apply to a variety technologies settings, including mobile applications, servers, and other technology platforms. Further, while the preceding examples provided reference to specific elements of a web-based portal and production platform, it will be apparent that the insurance interaction techniques are also applicable to other presentation environments and settings, including software applications, mobile device interfaces, and the like.

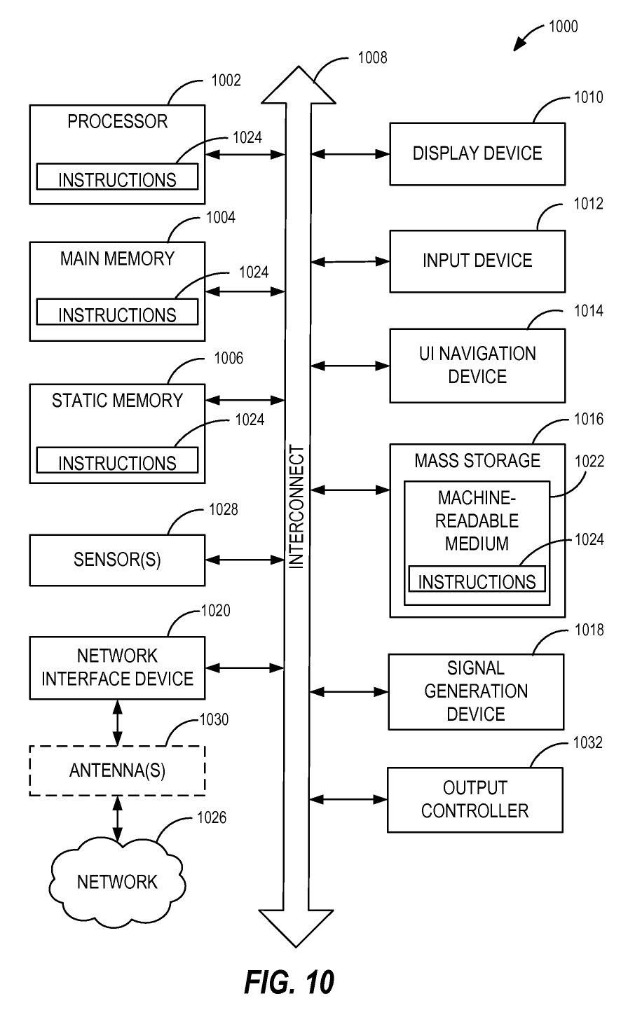

FIG. 10 is a block diagram illustrating an example computer system machine upon which any one or more of the methodologies herein discussed may be run. Computer system 1000 may be embodied as a computing device, providing operations of the electronic systems featured in FIG. 1, FIG. 2, FIG. 3, or FIG. 9, including the policy underwriting system 120, the claim servicing system, 132, the insurance marketplace web-based portal 208, the production platform 318, or the modules 910-990, or any other processing or computing platform or component described or referred to herein. In alternative embodiments, the machine operates as a standalone device or may be connected (e.g., networked) to other machines. In a networked deployment, the machine may operate in the capacity of either a server or a client machine in server-client network environments, or it may act as a peer machine in peer-to-peer (or distributed) network environments. The computer system machine may be a personal computer (PC) that may or may not be portable (e.g., a notebook or a netbook), a tablet, a set-top box (STB), a gaming console, a Personal Digital Assistant (PDA), a mobile telephone or smartphone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

Example computer system 1000 includes a processor 1002 (e.g., a central processing unit (CPU), a graphics processing unit (GPU) or both), a main memory 1004 and a static memory 1006, which communicate with each other via an interconnect 1008 (e.g., a link, a bus, etc.). The computer system 1000 may further include a video display unit 1010, an alphanumeric input device 1012 (e.g., a keyboard), and a user interface (UI) navigation device 1014 (e.g., a mouse). In one embodiment, the video display unit 1010, input device 1012 and UI navigation device 1014 are a touch screen display. The computer system 1000 may additionally include a storage device 1016 (e.g., a drive unit), a signal generation device 1018 (e.g., a speaker), an output controller 1032, and a network interface device 1020 (which may include or operably communicate with one or more antennas 1030, transceivers, or other wireless communications hardware), and one or more sensors 1028, such as a Global Positioning System (GPS) sensor, compass, location sensor, accelerometer, or other sensor.

The storage device 1016 includes a machine-readable medium 1022 on which is stored one or more sets of data structures and instructions 1024 (e.g., software) embodying or utilized by any one or more of the methodologies or functions described herein. The instructions 1024 may also reside, completely or at least partially, within the main memory 1004, static memory 1006, and/or within the processor 1002 during execution thereof by the computer system 1000, with the main memory 1004, static memory 1006, and the processor 1002 also constituting machine-readable media.

While the machine-readable medium 1022 is illustrated in an example embodiment to be a single medium, the term “machine-readable medium” may include a single medium or multiple media (e.g., a centralized or distributed database, and/or associated caches and servers) that store the one or more instructions 1024. The term “machine-readable medium” shall also be taken to include any tangible medium that is capable of storing, encoding or carrying instructions for execution by the machine and that cause the machine to perform any one or more of the methodologies of the present disclosure or that is capable of storing, encoding or carrying data structures utilized by or associated with such instructions. The term “machine-readable medium” shall accordingly be taken to include, but not be limited to, solid-state memories, optical media, and magnetic media. Specific examples of machine-readable media include non-volatile memory, including, by way of example, semiconductor memory devices (e.g., Electrically Programmable Read-Only Memory (EPROM), Electrically Erasable Programmable Read-Only Memory (EEPROM)) and flash memory devices; magnetic disks such as internal hard disks and removable disks; magneto-optical disks; and CD-ROM and DVD-ROM disks.

The instructions 1024 may further be transmitted or received over a communications network 1026 using a transmission medium via the network interface device 1020 utilizing any one of a number of well-known transfer protocols (e.g., HTTP). Examples of communication networks include a local area network (LAN), wide area network (WAN), the Internet, mobile telephone networks, Plain Old Telephone (POTS) networks, and wireless data networks (e.g., Wi-Fi, 3G, and 4G LTE/LTE-A or WiMAX networks). The term “transmission medium” shall be taken to include any intangible medium that is capable of storing, encoding, or carrying instructions for execution by the machine, and includes digital or analog communications signals or other intangible medium to facilitate communication of such software.

Other applicable network configurations may be included within the scope of the presently described communication networks. Although examples were provided with reference to a local area wireless network configuration and a wide area Internet network connection, it will be understood that communications may also be facilitated using any number of personal area networks, LANs, and WANs, using any combination of wired or wireless transmission mediums. The embodiments described above may be implemented in one or a combination of hardware, firmware, and software. While some embodiments described herein illustrate only a single machine or device, the terms ‘system’, ‘machine’, or ‘device’ shall also be taken to include any collection of machines or devices that individually or jointly execute a set (or multiple sets) of instructions to perform any one or more of the methodologies discussed herein.

Examples, as described herein, may include, or may operate on, logic or a number of components, modules, or mechanisms. Modules are tangible entities (e.g., hardware) capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine readable medium. In an example, the software, when executed by the underlying hardware of the module, causes the hardware to perform the specified operations.

Accordingly, the term “module” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times. Software may accordingly configure a hardware processor, for example, to constitute a particular module at one instance of time and to constitute a different module at a different instance of time.

Additional examples of the presently described method, system, and device embodiments include the following, non-limiting configurations. Each of the following non-limiting examples can stand on its own, or can be combined in any permutation or combination with any one or more of the other examples provided below, in the claims, or elsewhere in the present disclosure.

A first example can include the subject matter (embodied by an apparatus, a method, a means for performing acts, or a machine readable medium including instructions that, when performed by the machine, that can cause the machine to perform acts), for an insurance policy management system, comprising: electronic computing hardware including a processor and memory; an electronic data store configured for operation with the processor and memory, the electronic data store configured for storing data for designing and servicing of an insurance policy for a subject property, wherein the insurance policy is designed to provide insurance coverage for the subject property based on a plurality of pre-defined damage states specific to a type of catastrophic loss event; a damage scale categorization module configured for operation with the processor and memory, the damage scale categorization module configured for defining categorizations for assessment of the subject property under the insurance policy into the plurality of pre-defined damage states for the type of catastrophic loss event, wherein the categorizations are defined to estimate an extent of structural damage to the subject property caused by a particular catastrophic loss event, and wherein respective categorizations correlate to different manifestations of physical damage in individual building components for the subject property; an insurance policy design module configured for operation with the processor and memory, the insurance policy design module configured to assist with establishment of the insurance policy, including an inclusion of a damage scale indemnification clause in the insurance policy; a damage scale indemnity module configured for operation with the processor and memory, the damage scale indemnity module configured for correlating the respective categorizations to a range of monetary losses needed to repair or replace the subject property under the insurance policy upon occurrence of the particular catastrophic loss event; and a claims management module configured for operation with the processor and memory, the claims management module configured to assist with claims servicing of the insurance policy and determine an insurance claim payout for the subject property under the insurance policy based on the plurality of pre-defined damage states in response to an occurrence of the particular catastrophic loss event.

A second example can include, or can optionally be combined with the subject matter of the first example, to include subject matter (embodied by an apparatus, a method, a means for performing acts, or a machine readable medium including instructions that, when performed by the machine, that can cause the machine to perform acts), for operations for managing a damage scale insurance policy for insurance of a subject property against a particular type of catastrophic event, comprising operations performed by a computer system including a processor and memory, the operations including: determining categorizations for assessment of the subject property into a plurality of pre-defined damage states for the particular type of catastrophic event, wherein the respective categorizations are defined to categorize amounts of structural damage to the subject property caused by the particular type of catastrophic event, and wherein the respective categorizations correlate to different manifestations of physical damage in individual building components for the subject property; determining an indemnity payment schedule for the subject property under the damage scale insurance policy corresponding to the categorizations for assessment of the subject property, wherein the respective categorizations are associated with a range of monetary losses needed to repair or replace the subject property under the damage scale insurance policy upon occurrence of the particular type of catastrophic event; and defining characteristics of the damage scale insurance policy for the subject property, the damage scale insurance policy defined to include damage scale provisions in terms and conditions of the damage scale insurance policy, wherein the damage scale provisions correlate to the categorizations for assessment of the subject property into the plurality of pre-defined damage states and the indemnity payment schedule.

A third example can include, or can optionally be combined with the subject matter of one or any combination of the first and second example, to include subject matter (embodied by an apparatus, a method, a means for performing acts, or a machine readable medium including instructions that, when performed by the machine, that can cause the machine to perform acts), for storing data representing a damage scale-based insurance product, such as the data stored in a non-transitory machine-readable storage medium including: property characteristics of the subject property; catastrophic event characteristics of a particular type of catastrophic event; and a pre-defined damage scale for the particular type of catastrophic event; wherein the data stored in the non-transitory machine-readable storage device is utilized for the subject property from operations performed in a claims management computer system in communication with the data representing the damage scale-based insurance product stored on the machine-readable storage device, the data stored in the non-transitory machine-readable storage device utilized for the subject property from the operations that: collect visual property damage data corresponding to data stored on the machine-readable storage device for the property characteristics of the subject property; convert the visual property damage data into numeric inputs for a damage state assessment algorithm corresponding to data stored on the machine-readable storage device for the catastrophic event characteristics of the particular type of catastrophic event; calculate damage states for damage of the subject property corresponding to data stored on the machine-readable storage device for the pre-defined damage scale for the particular type of catastrophic event; and determine an indemnity payment corresponding to the calculated damage states of the subject property according to the damage scale-based insurance product.

The following claims are hereby incorporated into the detailed description, with each claim and identified combination of claims standing on its own as a separate example.

1. An insurance policy management system, comprising:
electronic computing hardware including a processor and memory;
an electronic data store configured for operation with the processor and memory, the electronic data store having data stored thereupon for designing and servicing of a damage scale insurance policy for a subject property, wherein the insurance policy provides insurance coverage for the subject property based on a plurality of pre-defined damage states specific to a particular type of catastrophic loss event, and wherein the insurance policy includes a damage scale indemnification clause;
an insurance policy design module configured for operation with the processor and memory, the insurance policy design module configured to perform operations to establish an electronic definition of the damage scale insurance policy with the operations including:
determining a plurality of damage categorizations for assessment of the subject property with use of the insurance policy design module, the damage categorizations including the plurality of pre-defined damage states for the particular type of catastrophic loss event, wherein the respective damage categorizations are defined to categorize amounts of structural damage to the subject property caused by the particular type of catastrophic loss event, and wherein the plurality of pre-defined damage states correlate to parameterized combinations of physical damage manifestations in a plurality of individual building components for the subject property;
determining an indemnity payment schedule for the subject property under the damage scale insurance policy with use of the insurance policy design module, the indemnity payment schedule establishing a plurality of payment amounts respectively corresponding to the damage categorizations, wherein the plurality of payment amounts that correspond to the respective damage categorizations provide a pre-defined estimated range of monetary losses needed to repair or replace the subject property under the damage scale insurance policy upon occurrence of the particular type of catastrophic loss event; and
establishing the electronic definition to indicate characteristics of the damage scale insurance policy for the subject property with use of the insurance policy design module, the damage scale insurance policy defined to include damage scale provisions in terms and conditions of the damage scale insurance policy, wherein the damage scale provisions correlate to the damage categorizations for assessment of the subject property using the plurality of pre-defined damage states and the indemnity payment schedule;
a claims management module configured for operation with the processor and memory, the claims management module configured to perform operations to assist with claims servicing of the damage scale insurance policy and determine an insurance claim payout for the subject property under the damage scale insurance policy based on the plurality of pre-defined damage states in response to an occurrence of a particular catastrophic loss event, with the operations including:
applying the plurality of damage categorizations in a damage scale method assessment algorithm with use of the claims management module, the damage scale method assessment algorithm applying the electronic definition of the damage scale insurance policy for evaluating damage to the plurality of individual building components of the subject property,
computing an estimate of a total amount of structural damage at the subject property in the damage scale method assessment algorithm with use of the claims management module, the computing using a weighted average of the plurality of pre-defined damage states applied to the plurality of individual building components of the subject property; and
establishing an electronic indication of data to represent the estimate of the total amount of structural damage at the subject property as a result of the occurrence of the catastrophic loss event, wherein the electronic indication is associated with a pre-defined payout according to the indemnity payment schedule.

2. The insurance policy management system of claim 1, wherein the claims management module is configured to determine the insurance claim payout for the subject property under the damage scale insurance policy based on the plurality of pre-defined damage states by performing operations to:
process visual property damage data originating from the subject property;
convert the visual property damage data into numeric inputs for a damage state algorithm;
determine a resulting damage state within the plurality of pre-defined damage states for insured risks defined in the damage scale insurance policy, using the numeric inputs of the damage state algorithm; and
select an indemnity payment corresponding to a resulting damage state within the plurality of pre-defined damage states, in compliance with the damage scale indemnification clause.

3. The insurance policy management system of claim 1, comprising:
a policy writing module configured to assist with design of the damage scale insurance policy for the subject property, the policy writing module configured to perform operations to:
determine property characteristics of the subject property;
determine catastrophic event risk characteristics for the particular catastrophic loss event relative to the property characteristics of the subject property;
interface with the insurance policy design module to establish the damage scale insurance policy to provide coverage for respective states of the plurality of pre-defined damage states for the particular catastrophic loss event, according to the property characteristics and the catastrophic event risk characteristics; and
store insurance policy definitions for the subject property included in the damage scale indemnification clause in the electronic data store.

4. The insurance policy management system of claim 3, wherein the claims management module is configured to perform servicing of the damage scale insurance policy for the subject property, by performing operations to:
process property damage information of damage to building components for the subject property resulting from the particular catastrophic loss event;
correlate the property damage information of damage to building components for the subject property to a damage categorization of the plurality of pre-defined damage states; and
select the insurance claim payout for the subject property based on the insurance policy definitions included in the damage scale indemnification clause;
wherein the pre-defined damage states include at least three damage states defining damage states to building components for the subject property.

5. The insurance policy management system of claim 3, wherein an interface to the policy writing module is provided via a web-based portal, the web-based portal providing a mechanism for an insurance agent or broker associated with at least one insurer to market respective insurance policies based on the plurality of pre-defined damage states to a plurality of consumers.

6. The insurance policy management system of claim 1, comprising:
a damage evaluation module configured to perform an automated evaluation of the physical damage of individual building components for the subject property and assist human evaluation of the physical damage of individual building components for the subject property, by correlating observable characteristics defined for the respective damage categorizations resulting from the particular catastrophic loss event to characteristics evaluated for the physical damage of individual building components.

7. The insurance policy management system of claim 1, wherein the particular catastrophic loss event is an earthquake or flood, and wherein the particular catastrophic loss event affects a plurality of insured properties across a geographic area, and wherein the claims management module utilizes detection and measurement information about the particular catastrophic loss event obtained from automated third party data sources to further assist with the claims servicing of the damage scale insurance policy.

8. A method for managing a damage scale insurance policy for insurance of a subject property against a particular type of catastrophic event, comprising operations performed by a computerized processing system including at least one processor and memory, the operations including:
establishing an electronic definition of the damage scale insurance policy with an insurance policy design module, the insurance policy design module implemented using the processor and memory, and the insurance policy design module configured to perform operations to establish the electronic definition of the damage scale insurance policy with the operations including:
determining a plurality of damage categorizations for assessment of the subject property with use of the insurance policy design module, the damage categorizations including a plurality of pre-defined damage states for the particular type of catastrophic event, wherein the respective damage categorizations are defined to categorize amounts of structural damage to the subject property caused by the particular type of catastrophic event, and wherein the plurality of pre-defined damage states correlate to parameterized combinations of physical damage manifestations in a plurality of individual building components for the subject property;
determining an indemnity payment schedule for the subject property under the damage scale insurance policy with use of the insurance policy design module, the indemnity payment schedule establishing a plurality of payment amounts respectively corresponding to the damage categorizations, wherein the plurality of payment amounts that correspond to the respective damage categorizations provide a pre-defined estimated range of monetary losses needed to repair or replace the subject property under the damage scale insurance policy upon occurrence of the particular type of catastrophic event; and
establishing the electronic definition to indicate characteristics of the damage scale insurance policy for the subject property with use of the insurance policy design module, the damage scale insurance policy defined to include damage scale provisions in terms and conditions of the damage scale insurance policy, wherein the damage scale provisions correlate to the damage categorizations for assessment of the subject property using the plurality of pre-defined damage states and the indemnity payment schedule;
performing electronic servicing of a claim under the damage scale insurance policy with a claims management module, the claims management module implemented using the processor and memory, and the claims management module configured to perform operations to evaluate property damage from an occurrence of a catastrophic event of the particular type of catastrophic event with the operations including:
applying the plurality of damage categorizations in a damage scale method assessment algorithm with use of the claims management module, the damage scale method assessment algorithm applying the electronic definition of the damage scale insurance policy for evaluating damage to the plurality of individual building components of the subject property,
computing an estimate of a total amount of structural damage at the subject property in the damage scale method assessment algorithm with use of the claims management module, the computing using a weighted average of the plurality of pre-defined damage states applied to the plurality of individual building components of the subject property; and
establishing an electronic indication of data to represent the estimate of the total amount of structural damage at the subject property as a result of the occurrence of the catastrophic event, wherein the electronic indication is associated with a pre-defined payout according to the indemnity payment schedule.

9. The method of claim 8, wherein the claims management system is configured for performing further operations including:
collecting visual property damage data for the subject property;
converting the visual property damage data into numeric inputs corresponding to the damage categorization for damage to individual building components using the plurality of pre-defined damage states;
calculating a damage state within the plurality of pre-defined damage states for risks insured by the damage scale insurance policy using the numeric inputs; and
selecting an indemnity payment from the plurality of payment amounts established for under the damage scale insurance policy, the selected indemnity payment corresponding to the calculated damage state.

10. The method of claim 8, comprising:
determining occurrence of the catastrophic event of the particular type of catastrophic event;
processing visual property damage data originating from the subject property;
converting the visual property damage data into numeric inputs for a damage state algorithm;
determining a resulting damage state within the plurality of pre-defined damage states for insured risks defined in the terms and conditions of the damage scale insurance policy, using the numeric inputs of the damage state algorithm; and
selecting an indemnity payment from the plurality of payment amounts corresponding to a resulting damage state within the plurality of pre-defined damage states, in compliance with a damage scale indemnification clause in the terms and conditions of the damage scale insurance policy.

11. The method of claim 10, comprising:
performing an automated evaluation of the damage of building components for the subject property and assisting human evaluation of the damage of building components for the subject property, by correlating observable characteristics defined for the respective categorizations occurring from the catastrophic event to characteristics observed for the damage state of the subject property.

12. The method of claim 10, wherein determining occurrence of the catastrophic event is performed based on environmental monitoring data from automated data sources, and wherein detection and measurement information about the catastrophic event are obtained from the automated data sources to further assist with claims servicing of the damage scale insurance policy.

13. The method of claim 8, comprising establishing the damage scale insurance policy using an insurance marketplace, wherein the insurance marketplace is accessible by a web-based portal, wherein the web-based portal provides a mechanism for an insurance agent associated with at least one insurer to market respective insurance policies based on the plurality of pre-defined damage states to a plurality of consumers.

14. The method of claim 8, wherein the terms and conditions of the damage scale insurance policy include a damage scale indemnification clause for providing an indemnity payment from the plurality of payment amounts according to the plurality of pre-defined damage states as determined in the indemnity payment schedule.

15. The method of claim 8, wherein the catastrophic event is an earthquake or flood, and wherein the catastrophic event affects a plurality of insured properties across a geographic area, and wherein the plurality of pre-defined damage states include at least three damage states defining moderate, severe, and total damage to the subject property.

16. At least one non-transitory machine-readable storage device storing data representing a damage scale-based insurance product, the data stored in the non-transitory machine-readable storage device including:
property characteristics of a subject property;
catastrophic event characteristics of a particular type of catastrophic event; and
a pre-defined damage scale for the particular type of catastrophic event;
wherein the data stored in the non-transitory machine-readable storage device is utilized for the subject property from operations performed in a claims management computer system in communication with the data representing the damage scale-based insurance product stored on the machine-readable storage device, the data stored in the non-transitory machine-readable storage device utilized for the subject property from the operations that:
determine a plurality of damage categorizations for assessment of the subject property, the damage categorizations including a plurality of pre-defined damage states for the particular type of catastrophic event, wherein the respective damage categorizations are defined to categorize amounts of structural damage to the subject property caused by the particular type of catastrophic event, and wherein the plurality of pre-defined damage states correlate to parameterized combinations of physical damage manifestations in a plurality of individual building components for the subject property;
determine an indemnity payment schedule for the subject property under the damage scale-based insurance product, the indemnity payment schedule establishing a plurality of payment amounts respectively corresponding to the damage categorizations, wherein the plurality of payment amounts that correspond to the respective damage categorizations provide a pre-defined estimated range of monetary losses needed to repair or replace the subject property under the damage scale-based insurance product upon occurrence of the particular type of catastrophic event; and
establish an electronic definition to indicate characteristics of the damage scale-based insurance product for the subject property, the damage scale-based insurance product defined to include damage scale provisions in terms and conditions of the damage scale-based insurance product, wherein the damage scale provisions correlate to the damage categorizations for assessment of the subject property using the plurality of pre-defined damage states and the indemnity payment schedule;
apply the plurality of damage categorizations in a damage scale method assessment algorithm with use of the claims management module, the damage scale method assessment algorithm applying the electronic definition of the damage scale-based insurance product for evaluating damage to the plurality of individual building components of the subject property,
compute an estimate of a total amount of structural damage at the subject property in the damage scale method assessment algorithm with use of the claims management module, the computing using a weighted average of the plurality of pre-defined damage states applied to the plurality of individual building components of the subject property; and
establish an electronic indication of data to represent the estimate of the total amount of structural damage at the subject property as a result of the occurrence of a catastrophic event, wherein the electronic indication is associated with a pre-defined payout according to the indemnity payment schedule;
collect visual property damage data corresponding to data stored on the machine-readable storage device for the property characteristics of the subject property;
convert the visual property damage data into numeric inputs for a damage scale method algorithm corresponding to data stored on the machine-readable storage device for the catastrophic event characteristics of the particular type of catastrophic event;
calculate damage states for damage of the subject property corresponding to data stored on the machine-readable storage device for the pre-defined damage scale for the particular type of catastrophic event; and
select an indemnity payment from the plurality of payment amounts established for the damage scale-based insurance product, the selected indemnity payment corresponding to the calculated damage state.

17. The non-transitory machine-readable storage device of claim 16 storing data representing the damage scale-based insurance product, wherein the data stored in the non-transitory machine-readable storage device is used for calculating an insurance claim of the subject property from claim servicing operations performed in a computer system in operable communication with the non-transitory machine-readable storage device, with operations that:
determine property damage to individual classes of building components;
determine an overall property damage state to an average of the property damage to the individual classes of building components; and
correlate an overall property damage state to a defined damage state.

18. The non-transitory machine-readable storage device of claim 17 storing data representing the damage scale-based insurance product, wherein the operations that determine property damage to the individual classes of building components include operations that determine a category for the damage for each type of building component of the subject property, with operations that:
match the damage for the type of building component to a damage pattern classification;
determine the damage for the type of building component on a numerical scale; and
classify the damage for the type of building component from the numerical scale to the category;
wherein the operations that determine an overall property damage state to an average of the property damage to the individual classes of building components also determine an average damage category of the subject property from the category for the damage for each type of building component.

19. The non-transitory machine-readable storage device of claim 16 storing data representing the damage scale-based insurance product, wherein the catastrophic event characteristics are specific to the type of catastrophic event, wherein catastrophic event characteristics are defined for one or both of an earthquake or a flood, wherein the pre-defined damage scale includes at least three damage states defining minor, major, and total damage to the subject property.

20. The non-transitory machine-readable storage device of claim 16 storing data representing the damage scale-based insurance product, wherein the data stored in the non-transitory machine readable storage device further includes a damage scale payout, including a payout value for each of a plurality of damage states, a coverage amount for the subject property, term information, exclusion information, policy limits, deductible value, replacement value, incidental coverage, and settlement conditions.
